(19) United States
(12) Patent Application Publication
(10) Pub. No.: US 2017/0366534 A1
(43) Pub. Date: Dec. 21, 2017

(54) APPLICATION DELIVERY METHOD, COMPUTER-READABLE RECORDING MEDIUM, AND SERVER

(71) Applicant: FUJITSU LIMITED, Kawasaki-shi (JP)

(72) Inventors: Tadanobu TSUNODA, Yokohama (JP); Zhaogong GUO, Koto (JP); Naoki NISHIGUCHI, Kawasaki (JP); Akira FUJII, Machida (JP)

(73) Assignee: FUJITSU LIMITED, Kawasaki-shi (JP)

(21) Appl. No.: 15/674,857

(22) Filed: Aug. 11, 2017

Related U.S. Application Data
(63) Continuation of application No. PCT/JP2015/054290, filed on Feb. 17, 2015.

(51) Int. Cl. H04L 29/06

(52) U.S. Cl. CPC H04L 63/083; H04L 63/0428

(57) ABSTRACT

An application delivery method includes detecting, by a server, a first terminal present in a specific area and transmitting, by the server, to the detected first terminal, a first application associated with the specific area and a second application having a function of relaying the first application to a second terminal; and invoking, by the first terminal, the second application outside the specific area and transmitting by the first terminal using the second application, the first application to the second terminal that has been detected.

### CROSS REFERENCE TO RELATED APPLICATIONS

This application is a continuation application of International Application PCT/JP2015/054290, filed on Feb. 17, 2015, and designating the U.S., the entire contents of which are incorporated herein by reference.

### FIELD

The embodiments discussed herein are related to an application delivery method, a computer-readable recording medium, and a server.

### BACKGROUND

Conventionally, there is a technique of Installing a server at, for example, a store or a school to deliver to terminals of people gathered near the store or students registered at the school, a coupon app that may be used at the store, a teaching material app used in a lesson, etc. By locally installing a server at a place such as a store, a school, etc., the technique enables services related to the place to be provided to users who have gathered there.

As a prior art, for example, there is a technique of using a low-sensitivity base station in a mobile communications system to narrow a position detection range whereby spot position detection becomes possible; the user is caused to respond by the user terminal; and on the basis of position information and personal information, information is delivered and a service is provided. According to another technique, at a relay terminal that relays packet communication between a base station and a destination terminal located outside the service area of the base station, a degree of contribution of relay is measured and the measurement result is transmitted to a billing server whereby a grant of incentives to the relay terminal becomes possible. Further, there is a technique related to a method of protecting personal information to prevent personal information leaks due to, for example, theft or loss of a mobile telephone terminal. There is a further technique of using a self-propagating function to install a client agent program in a new client. For examples, refer to Japanese Laid-Open Patent Publication No. 2004-242052, International Publication No. WO 2003/032617, Japanese Laid-Open Patent Publication No. 2007-318245, and Japanese Laid-Open Patent Publication No. 2005-157587.

### SUMMARY

According to an aspect of an embodiment, an application delivery method includes detecting, by a server, a first terminal present in a specific area and transmitting, by the server, to the detected first terminal, a first application associated with the specific area and a second application having a function of relaying the first application to a second terminal; and invoking, by the first terminal, the second application outside the specific area and transmitting by the first terminal using the second application, the first application to the second terminal that has been detected.

The object and advantages of the invention will be realized and attained by means of the elements and combinations particularly pointed out in the claims. [0007] it is to be understood that both the foregoing general description and the following detailed description are exemplary and explanatory and are not restrictive of the invention.

### BRIEF DESCRIPTION OF DRAWINGS

FIG. 1 is a diagram depicting an example of an application delivery method according to a first embodiment;

FIG. 2 is a diagram depicting a system configuration example of an application delivery system 200;

FIG. 3 is a block diagram of an example of hardware configuration of a server 101 according to the first embodiment;

FIG. 4 is a block diagram of an example of hardware configuration of a terminal Ti according to the first embodiment;

FIG. 5 is a diagram depicting an example of contents of an authentication DB 220;

FIG. 6 is a diagram depicting an example of contents of a delivery app list 230;

FIG. 7 is a diagram depicting an example of contents of a downloaded-app list 700;

FIG. 8 is a block diagram of an example of a functional configuration of the server 101 according to the first embodiment;

FIG. 9 is a block diagram of an example of a functional configuration of the terminal Ti according to the first embodiment:

FIG. 10 is a diagram depicting an example of updating of the downloaded-app list 700;

FIGS. 11, 12, 13, and 14 are diagrams depicting generation examples of an encryption key and a decryption key;

FIG. 15 is a diagram depicting an example of contents of a relay terminal authentication DB 1500;

FIG. 16 is a diagram depicting an example of contents of a relay app list 1600;

FIG. 17 is a block diagram of an example of a functional configuration of a relay terminal Ti according to the first embodiment;

FIG. 18 is a flowchart of an example of a procedure of an application delivery process by the server 101 according to the first embodiment;

FIGS. 19 and 20 are flowcharts of an example of a procedure of an application execution process by the terminal Ti according to the first embodiment;

FIG. 21 is a flowchart of an example of a procedure of an application relay process by the relay terminal Ti according to the first embodiment;

FIG. 22 is a diagram depicting an example of the application delivery method according to a second embodiment;

FIG. 23 is a diagram depicting a system configuration example of an application delivery system 2300;

FIG. 24 is a block diagram of an example of hardware configuration of a mobile server MSi;

FIG. 25 is a diagram depicting a detailed example of server information 2310;

FIG. 26 is a diagram depicting a detailed example of terminal information 2320;

FIG. 27 is a block diagram of an example of a functional configuration of the server 2201 according to the second embodiment;

FIG. 28 is a diagram depicting a detailed example of network configuration information;

FIG. 29 is a diagram depicting a detailed example of network information;

FIG. 30 is a block diagram of an example of a functional configuration of the terminal Ti according to the second embodiment;

FIG. 31 is a block diagram of an example of a functional configuration of the mobile server MSi according to the second embodiment;

FIG. 32 is a flowchart of an example of a procedure of a terminal information upload process by the terminal Ti according to the second embodiment;

FIG. 33 is a flowchart of an example of a procedure of a load distribution process by a server 2201 according to the second embodiment;

FIG. 34 is a flowchart of an example of a procedure of a mobile server enabling process by a terminal Ti according to the second embodiment;

FIG. 35 is a flowchart of an example of a procedure of an application delivery process by the mobile server MSi according to the second embodiment; and

FIG. 36 is a flowchart of an example of a procedure of an application acquiring process by the terminal Ti according to the second embodiment.

### DESCRIPTION OF THE INVENTION

Embodiments of an application delivery method, an application delivery program, and a server according to the present invention will be described in detail with reference to the accompanying drawings.

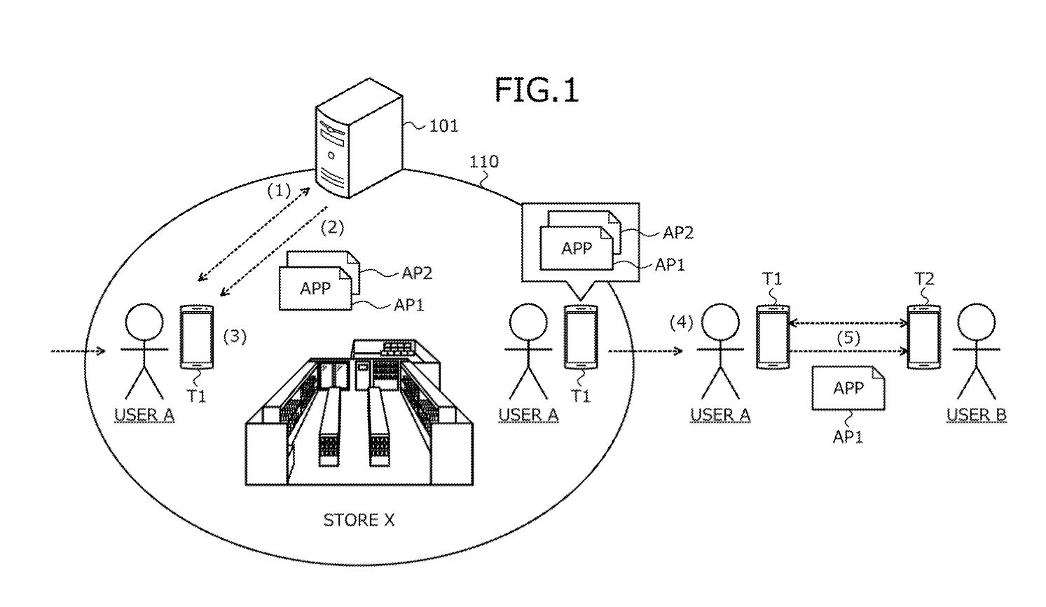

FIG. 1 is a diagram depicting an example of the application delivery method according to a first embodiment. In FIG. 1, a server 101 is a computer configured to deliver an application. Further, a terminal apparatus T (for example, terminal apparatuses T1, T2) is a computer configured to perform wireless communication and is, for example, a smartphone, a mobile telephone, a tablet-type personal computer (PC), etc.

The server 101 is installed at, for example, a store, a school, an event venue, etc. and delivers an application to the terminal apparatus T of a student registered at the school, a visitor of the store or the event venue, etc. The application to be delivered is an encrypted application associated with a specific area and may be decrypted in the specific area.

For example, when the server 101 is installed at a store, the application to be delivered is a coupon app that may be used at the store, etc. In this case, the specific area in which the coupon app may be decrypted and executed, for example, is a local area near the store where the server 101 is installed.

Further, for example, when the server 101 is installed at a school, the application to be delivered is a teaching material app used in a lesson, etc. In this case, the specific area in which the teaching material app may be decrypted and executed is, for example, a local area near a classroom or the like in the school where the server 101 is installed.

In other words, by installing the server 101 in a store, a school, etc., users in a local area near the store, a classroom in the school, etc. may be provided a service related to the area. On the other hand, when access to the server 101 installed at the store, the school, etc. suddenly increases, load for delivering the application concentrates.

For example, when the load on the server 101 for delivery of a coupon app concentrates, distribution of the coupon app to visitors takes time and a business opportunity may be lost. Further, for example, when the load on the server 101 for delivery of a teaching material app concentrates, distribution of the teaching material app to students takes time, inviting delays in the start of a lesson.

Thus, in the first embodiment, a method of suppressing load concentration at the server 101 by a distribution of the load for delivering an application executable in a specific area will be described. Hereinafter, a processing example of the server 101 and the terminal apparatus T will be described taking a case in which the server 101 is installed at a store X as an example. Here, the specific area in which an application to be delivered is executable is assumed to be an area 110 near the store X.

(1) The server 101 detects the terminal apparatus T present in the area 110. In particular, for example, the server 101 detects the terminal apparatus T configured for short-range wireless communication and receives position information from the detected terminal apparatus T. The server 101 determines whether the terminal apparatus T is located in the area 110, based on the received position information and thereby detects the terminal apparatus T present in the area 110.

Short-range wireless communication is wireless communication having a communication distance up to about several tens of meters. For example, communication using a wireless local area network (LAN), Bluetooth (registered trademark), ZigBee (registered trademark), and the like may be given as an example of short-range wireless communication. Further, area information identifying the area 110 is, for example, stored in a storage apparatus of the server 101.

In the example depicted in FIG. 1, as a result of user A entering the area 110, the terminal apparatus T1 of user A is detected as a terminal apparatus T present in the area 110.

(2) The server 101 transmits an application AP1 and an application AP2 to the terminal apparatus T when the terminal apparatus T present in the area 110 is detected. Here, the application AP1 is an encrypted application associated with the area 110 and, for example, is a coupon app that may be used at the store X.

Further, the application AP2 is a relay application having a function of relaying the application AP1 to another terminal apparatus T. For example, area information identifying the area 110 is appended to the application AP1. The area information is, for example, information indicating coordinate positions of vertices of a diagonal of the area 110, when the area 110 is a rectangular region.

In the example depicted in FIG. 1, the applications AP1, AP2 are transmitted from the server 101 to the terminal apparatus T1 present in the area 110.

(3) The terminal apparatus T1, when receiving the applications AP1, AP2 from the server 101, may decrypt and execute the application AP1 in the area 110. In particular, for example, the area 110, the terminal apparatus T1 may decrypt the application AP1 by receiving a decryption key from the server 101.

In the example depicted in FIG. 1, at the terminal apparatus T1, the application AP1 may be decrypted and executed in the area 110 thereby enabling user A to use the coupon app. etc. at the store X.

The terminal apparatus T1 may be configured to automatically execute the application AP1 in response to the application AP1 becoming executable. Further, the terminal apparatus T1 may be configured to give notification that the application AP1 has become executable and to receive an execution instruction from user A.

(4) The terminal apparatus T1 Invokes the application AP2 outside the area 110. In particular, for example, terminal apparatus T1 obtains the position information of the terminal apparatus T1 and determines whether the terminal apparatus T1 is located in the area 110. The terminal apparatus T1 invokes the application AP2, when determining that the terminal apparatus T1 is outside the area 110.

In the example depicted in FIG. 1, when user A leaves the store X and the terminal apparatus T1 is outside the area 110, the application AP2 is invoked in the terminal apparatus T1.

(5) The terminal apparatus T1, when having invoked the application AP2, performs detection for another terminal apparatus T configured for short-range wireless communication. The terminal apparatus T1, when detecting another terminal apparatus T, transmits the application AP1 to the detected terminal apparatus T.

In the example depicted in FIG. 1, the terminal apparatus T2 capable of short-range wireless communication with the terminal apparatus T1 is assumed to be detected. In this case, the terminal apparatus T1 transmits the encrypted application AP1 to the terminal apparatus T2.

Configuration may be such that the terminal apparatus T2, when receiving the application AP1 from the terminal apparatus T1 and, for example, moving into the area 110, receives a decryption key from the server 101 and decrypts and executes the application AP1. In this case, the server 101 does not deliver the application AP1 to the terminal apparatus T2.

In this manner, according to the server 101, the application AP1 associated with the area 110, and the application AP2 invoked outside the area 110 and relaying the application AP1 to another terminal apparatus T may be delivered to a terminal apparatus T in the area 110. As a result, outside the area 110, for example, the terminal apparatus T1 of user A may be used to deliver the application AP1 executable in the area 110 to the terminal apparatus T2 of user B different from user A.

As a result, when user B moves into the area 110, delivery of the application AP1 from the server 101 to the terminal apparatus T2 becomes unnecessary, enabling load concentration on the server 101 for delivery of the application AP1 to be suppressed. Further, delivery of the application AP1 by the terminal apparatus T1 is performed outside the area 110 thereby enabling a concentration of network load in the area 110 (service area) to be prevented.

A system configuration example of an application delivery system 200 according to the first embodiment will be described.

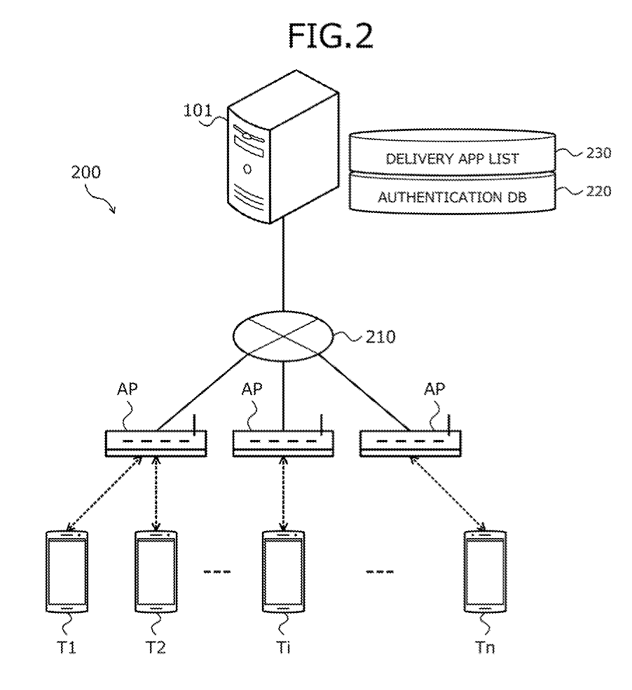

FIG. 2 is a diagram depicting a system configuration example of the application delivery system 200. In FIG. 2, the application delivery system 200 includes the server 101, 1 or more access points AP (3 in the example depicted in FIG. 2), and terminal apparatuses T1 to Tn (n: natural number of 2 or more). In the application delivery system 200, the server 101 and the access points AP are connected via a wired or wireless network 210. The network 210, for example, includes a LAN, a wide area network (WAN), the Internet, etc.

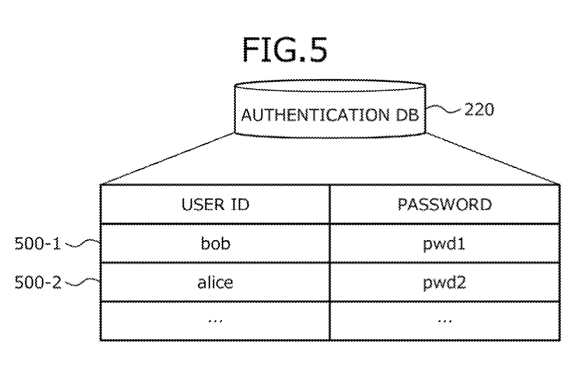

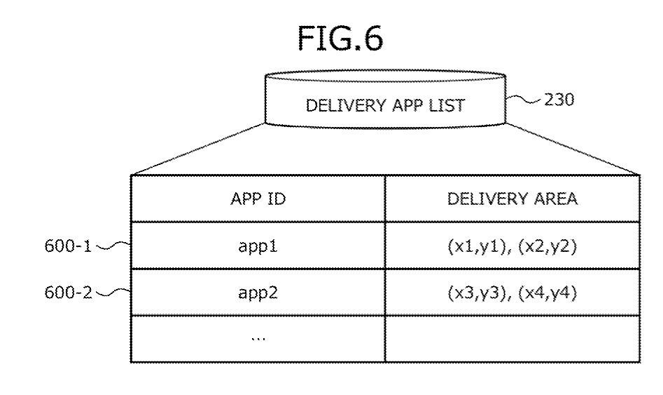

The server 101 has an authentication database (DB) 220 and a delivery app list 230. Contents of the authentication DB 220 and the delivery app list 230 will be described hereinafter with reference to FIGS. 5 and 6. The server 101, as described above, for example, is installed at a store, a school, an event venue, etc.

Further, the access points AP are access points of a wireless LAN. For example, when the server 101 is installed at a store, the access points AP are installed at the same store as the server 101. Further, for example, when the server 101 is installed at a school, the access points AP are installed in classrooms or the like in the school at which the server 101 is installed. Further, for example, when the server 101 is installed at an event venue, the access points AP are installed at the event venue at which the server 101 is installed.

The terminal apparatuses T1 to Tn are configured to enable wireless communication with an access point AP when within a communication range of the access point AP and to connect to the server 101 through the access point AP. In the description hereinafter, the terminal apparatuses T1 to Tn may be indicated as simply “terminals T1 to Tn” and an arbitrary terminal among the terminals T1 to Tn may be indicated as “terminal Ti” (i=1, 2, . . . , n).

In the description above, while a case in which a terminal Ti is connected to the server 101 through the access points AP installed at each location in the application delivery system 200 is described as an example, configuration is not limited hereto. For example, a terminal Ti may be connected to the server 101 through a wireless LAN access point built into the server 101.

An example of hardware configuration of the server 101 will be described.

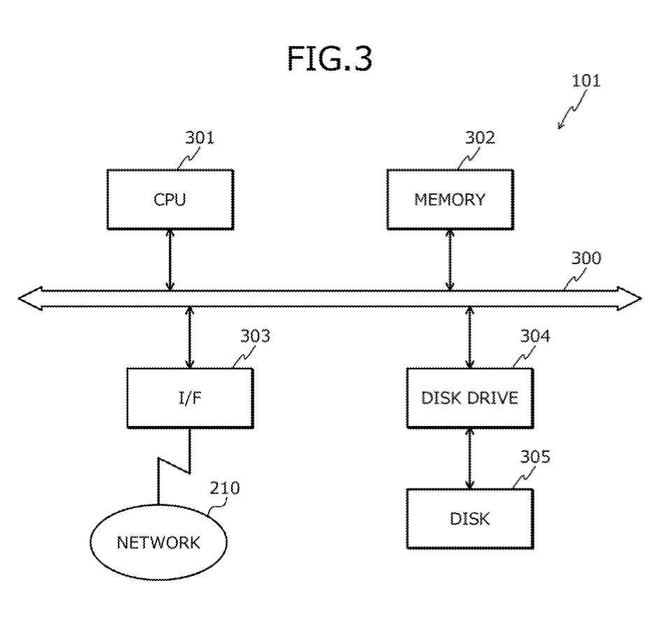

FIG. 3 is a block diagram of an example of hardware configuration of the server 101 according to the first embodiment. In FIG. 3, the server 101 has a central processing unit (CPU) 301, a memory 302, an interface (I/F) 303, a disk drive 304, and a disk 305, respectively connected by a bus 300.

Here, the CPU 301 governs overall control of the server 101. The memory 302, for example, includes read-only memory (ROM), random access memory (RAM), and flash ROM. In particular, for example, the flash ROM and ROM store various types of programs; and the RAM is used as work area of the CPU 301. A program stored in the memory 302 is loaded onto the CPU 301 whereby an encoded process is executed by the CPU 301.

The I/F 303 is connected to the network 210 through a communications line and is connected to another apparatus (for example, a terminal Ti depicted in FIG. 2) via the network 210. The I/F 303 administers an internal interface with the network 210 and controls the input and output of data from another apparatus. A modem or LAN adapter, for example, may be employed as the I/F 303.

The disk drive 304, under the control of the CPU 301, controls the reading and writing of data with respect to the disk 305. The disk 305 stores data written thereto under the control of the disk drive 304. For example, the disk 305 may be a magnetic disk, an optical disk, or the like.

In addition to the configuration above, the server 101 may have, for example, a solid state drive (SSD), a keyboard, a mouse, a display, etc. Further, the access points AP depicted in FIG. 2 may also be implemented by a hardware configuration identical to that of the server 101 above.

An example of a hardware configuration of a terminal Ti will be described.

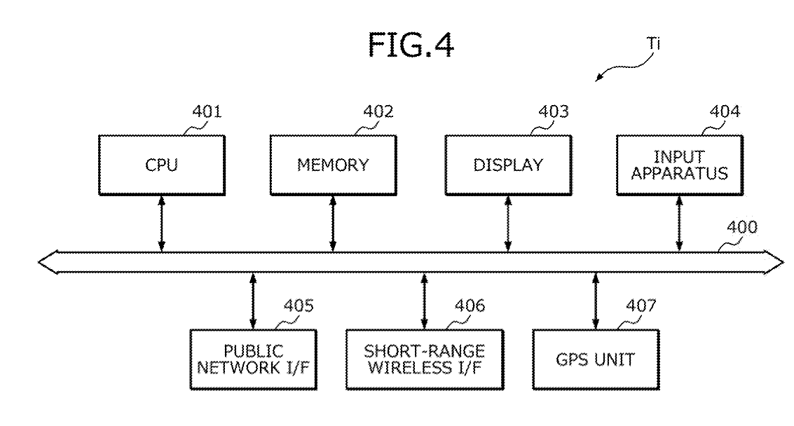

FIG. 4 is a block diagram of an example of hardware configuration of the terminal Ti according to the first embodiment. In FIG. 4, the terminal Ti has a CPU 401, a memory 402, a display 403, an input apparatus 404, a public network I/F 405, a short-range wireless I/F 406, and a global positioning system (GPS) unit 407, respectively connected by a bus 400.

Here, the CPU 401 governs overall control of the terminal Ti. The memory 402 includes, for example, ROM, RAM, and flash ROM. In particular, for example, flash ROM stores an OS program; the ROM stores an application program; and the RAM is used as a work area of the CPU 401. A program stored in the memory 402 is loaded onto the CPU 401 whereby an encoded process is executed by the CPU 401.

The display 403 displays a cursor, icons or toolboxes in addition to data such as documents, images, functional information, and the like. For example, a liquid crystal display, an organic electroluminescence (EL) display, or the like may be employed as the display 403.

The input apparatus 404 has keys for the input of characters, numerals, various instructions, etc. and performs data input. The input apparatus 404 may be a keyboard or a mouse, or may be a touch-panel input pad, a numeric key pad, etc.

The public network I/F 405 is connected to a public network through a communications line and is connected to another apparatus via the public network. The public network I/F 405 administers an internal interface with the public network and controls the input and output of data from other apparatuses.

The short-range wireless I/F 406 is connected to a short-range wireless network and is connected to another apparatus via the short-range wireless network. The short-range wireless I/F 406 administers an internal interface with the short-range wireless network and controls the input and output of data from another apparatus. For example, a mobile communications modem, a network communications chip, etc. may be employed as the public network I/F 405 and the short-range wireless I/F 406.

The GPS unit 407 receives signals from a GPS satellite and outputs position Information Indicating a position of the terminal Ti. The position information of the terminal Ti is, for example, information identifying one point on the earth such as by latitude, longitude, altitude, etc. In addition to the configuration above, the terminal Ti may have, for example, a disk drive, a disk, a SSD, etc.

Contents of the authentication DB 220 retained by the server 101 will be described. The authentication DB 220 is implemented by, for example, a storage apparatus such as the memory 302 or the disk 305 depicted in FIG. 3 or the like.

FIG. 5 is a diagram depicting an example of the contents of the authentication DB 220. In FIG. 5, the authentication DB 220 has fields for user IDs and passwords, and by a setting of information into the fields, stores authentication information (for example, authentication information 500-1, 500-2) as records. In the example depicted in FIG. 5, although the authentication information is described in plain text, for example, the authentication information is stored in the authentication DB 220 in an encrypted state.

The user ID is an identifier that identifies the user of the terminal Ti. The password is the password of the user of the terminal Ti. The user ID and the password, for example, are used in authenticating the user. For example, the authentication information 500-1 indicates a user ID “bob” and a password “pwd1”.

Contents of the delivery app list 230 retained by the server 101 will be described. The delivery app list 230 is implemented by, for example, a storage apparatus such as the memory 302 or the disk 305 depicted in FIG. 3 or the like.

FIG. 6 is a diagram depicting an example of the contents of the delivery app list 230. In FIG. 6, the delivery app list 230 has fields for app IDs and delivery areas, and by a setting of information into the fields, stores delivery app information (for example, delivery app information 600-1, 600-2) as records.

The app ID is an identifier that identifies an application to be delivered. The delivery area corresponds to “specific area” described above and is represented by information that identifies the area in which the application is to be delivered. Here, the delivery area indicates coordinate positions of vertices of a diagonal of a rectangular region on the earth.

For example, the delivery app information 600-1 indicates an app ID “app1” and a delivery area “(x1, y1), (x2, y2)”. The application corresponding to the app ID, for example, is stored in a storage apparatus such as the memory 302, the disk 305, etc.

Contents of a downloaded-app list 700 retained by the terminal Ti will be described. The downloaded-app list 700 is implemented by, for example, the memory 402 depicted in FIG. 4.

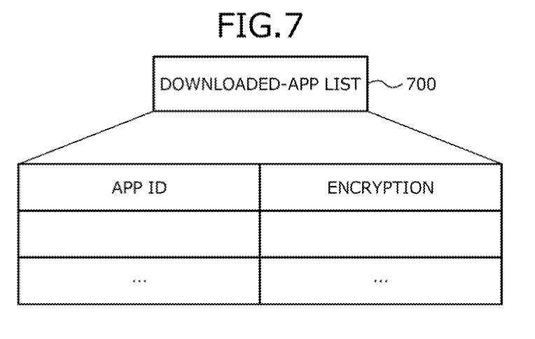

FIG. 7 is a diagram depicting an example of the contents of the downloaded-app list 700. In FIG. 7, the downloaded-app list 700 has fields for app IDs and encryption, and by a setting of information into the fields, stores downloaded app information as records.

Here, the app ID is an identifier that identifies an application that has been downloaded. Encryption indicates whether the downloaded application is encrypted. In the encryption field, “true” is set when the application is encrypted and “false” is set when the encrypted application has been decrypted.

In the example depicted in FIG. 7, since no application has downloaded by the terminal Ti, the app ID field and the encryption field are “blank”.

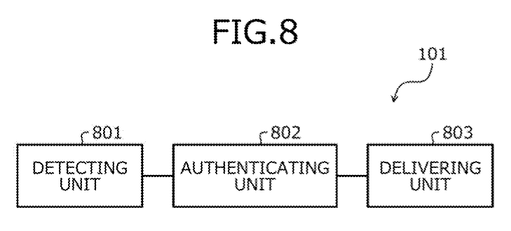

FIG. 8 is a block diagram of an example of a functional configuration of the server 101 according to the first embodiment. In FIG. 8, the server 101 is configured including a detecting unit 801, an authenticating unit 802, and a delivering unit 803. The detecting unit 801 to the delivering unit 803 are functions constituting a control unit and, for example, are implemented by executing on the CPU 301, a program stored in a storage apparatus such as the memory 302 or the disk 305 depicted in FIG. 3 or the like, or by the I/F 303. Processing results of the functional units are stored to, for example, a storage apparatus such as the memory 302, the disk 305, etc.

The detecting unit 801 detects a terminal Ti configured to perform wireless communication. In particular, for example, the detecting unit 801 detects a terminal Ti configured to perform wireless communication, via the access points AP depicted in FIG. 2. As a result, a terminal Ti present within the communication range of an access point AP may be detected.

The authenticating unit 802, when a terminal Ti configured to perform wireless communication is detected, performs an authentication process for the terminal Ti. In particular, for example, first, when the terminal Ti configured to perform wireless communication is detected, the authenticating unit 802 connects to the terminal Ti and transmits an authentication request. Here, the authentication request requests authentication of whether the user of the terminal Ti is a valid user of the application delivery system 200.

Next, the authenticating unit 802 receives user information from the terminal Ti. Here, the user information includes, for example, a user ID and a password, etc. input to an authentication screen of the terminal Ti. The authenticating unit 802 performs the authentication process for the terminal Ti, based on the user information received from the terminal Ti.

In more detail, for example, the authenticating unit 802 decodes the received user information and from the authentication DB 220 (for example, refer to FIG. 5), identifies a password that corresponds to the user ID included in the user information. The authenticating unit 802 compares the identified password and the password included in the user information.

The authenticating unit 802 authenticates the terminal Ti (authentication successful), when the passwords match. On the other hand, the authenticating unit 802 does not authenticate the terminal Ti (authentication failed), when the passwords do not match. Further, the authenticating unit 802 does not authenticate the terminal Ti (authentication failed), when being unable to identify in the authentication DB 220, a password that corresponds to the user ID included in the user information.

The delivering unit 803, when the terminal T1 is authenticated, determines whether the terminal Ti is present in the delivery area of the application to be delivered. In the description hereinafter, an application to be delivered may be indicated as simply “delivery app”.

In particular, for example, first, when the terminal Ti is authenticated, the delivering unit 803 receives from the terminal Ti, position information and the downloaded-app list 700 (for example, refer to FIG. 7). Next, the delivering unit 803, for example, refers to the delivery app list 230 depicted in FIG. 6 to identify the delivery area of the delivery app. The delivering unit 803 determines whether the terminal Ti is present in the delivery area of the delivery app, based on the received position information of the terminal Ti.

When plural delivery areas are identified from the delivery app list 230, the delivering unit 803 determines for each of the delivery areas, whether the terminal Ti is present in the delivery area.

Further, when determining that the terminal Ti is present in a delivery area, the delivering unit 803 determines whether the delivery app is included in the received downloaded-app list 700. As one example, a case is assumed in which the terminal Ti is present in the delivery area of an application of the app ID “app1”.

In this case, the delivering unit 803 refers to the downloaded-app list 700 and determines whether the application of the app ID “app1” is included therein. In the example depicted in FIG. 7, the delivering unit 803 determines that the application of the app ID “app1” is not included in the downloaded-app list 700.

Further, when the delivery app is not included in the downloaded-app list 700, the delivering unit 803 transmits the delivery app and an app relay service to the terminal Ti. Here, the app relay service is an application having a function of relaying a delivery app to another terminal Tj (j≠i, j=1, 2, . . . , n).

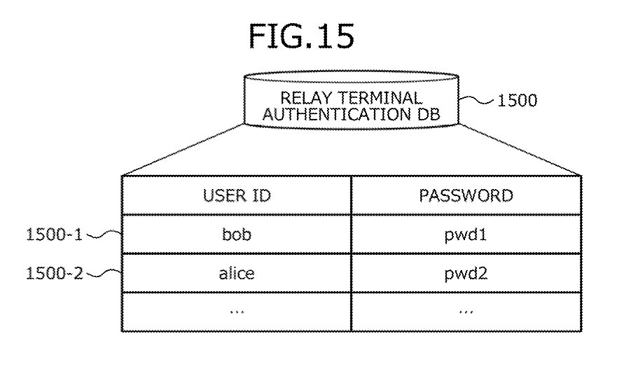

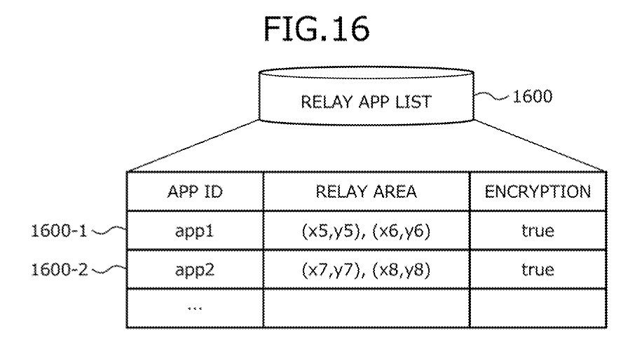

Further, the app relay service has a function of detecting another terminal Tj configured for short-range wireless communication with the terminal Ti and connecting to the detected terminal Tj. The app relay service has a further function of authenticating the terminal Tj. The app relay service may include, for example, information (refer to FIG. 16 described hereinafter) identifying an area to which the delivery app may be relayed, authentication information (refer to FIG. 15 described hereinafter) for authenticating the terminal Tj, etc. The application AP2 depicted in FIG. 1, for example, corresponds to the app relay service.

Further, the delivering unit 803 may transmit a decryption app together with the delivery app to the terminal Ti. Here, the decryption app is an application for decrypting the encrypted delivery app. The delivery app is encrypted by, for example, an encryption key generated using position information that corresponds to the delivery area. Further, information (for example, refer to the delivery area depicted in FIG. 6) identifying the delivery area may be appended to the delivery app.

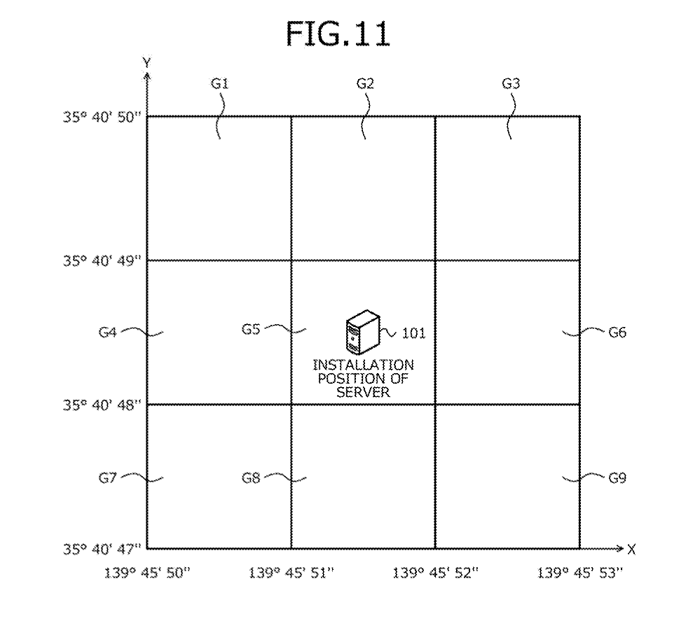

In particular, for example, the delivering unit 803 generates as the encryption key, a hash value obtained by providing to a hash function, latitude/longitude information identified from position information that corresponds to the delivery area. The delivering unit 803 uses the generated encryption key to encrypt the delivery app. A generation example of an encryption key for encrypting a delivery app will be described with reference to FIGS. 11 to 14.

The position information that corresponds to the delivery area may be, for example, position information identified from the installation position of the server 101 or may be position information identified from the installation positions of the access points AP installed associated with the server 101. Alternatively, the position information that corresponds to the delivery area may be position information identified from coordinate positions of vertices of a diagonal of the delivery area indicated in the delivery app list 230.

Further, the app relay service, similar to the delivery app, may be transmitted to the terminal Ti in an encrypted state. In this case, the delivering unit 803, for example, may transmit a decryption key together with the app relay service to the terminal Ti. Here, the decryption key is key information for decrypting the encrypted app relay service.

The delivering unit 803 does not transmit the app relay service to the terminal Ti when the app relay service is not included in the downloaded-app list 700.

Further, the delivering unit 803 may transmit to the terminal Ti present in the delivery area, a decryption key for decrypting the delivery app. In particular, for example, the delivering unit 803 may transmit to the terminal Ti present in the delivery area, a decryption key together with the delivery app. Further, the delivering unit 803 may transmit the decryption key of the delivery app to the terminal Ti in response to receiving from the terminal Ti present in the delivery area, an acquisition request for the decryption key of the delivery app.

In the description above, while the delivering unit 803 has been described to transmit the delivery app to a terminal Ti present in the delivery area, configuration is not limited hereto. For example, the delivering unit 803 may be configured to transmit to a terminal Ti present in the delivery area, information indicating a storage location of a delivery app such as a Uniform Resource Locator (URL). The storage location of a delivery app, for example, may be on the server 101 or may be on a computer different from the server 101.

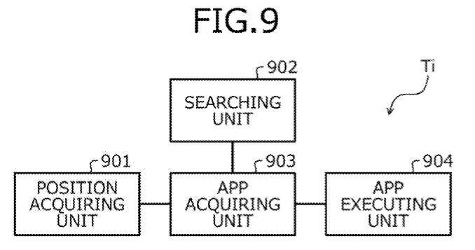

FIG. 9 is a block diagram of an example of a functional configuration of a terminal Ti according to the first embodiment. In FIG. 9, the terminal Ti is configured including a position acquiring unit 901, a searching unit 902, an app acquiring unit 903, and an app executing unit 904. The position acquiring unit 901 to the app executing unit 904 are functions constituting a control unit and, for example, are implemented by executing on the CPU 401, a program stored in the memory 402 depicted in FIG. 4, or by the public network I/F 405 or the short-range wireless I/F 406. Processing results of the functional units are stored to, for example, the memory 402.

The position acquiring unit 901 acquires the position information of the terminal Ti. In particular, for example, the position acquiring unit 901 acquires the position information via the GPS unit 407.

The searching unit 902 searches for the server 101 configured to perform wireless communication. In particular, for example, the searching unit 902 scans the access points AP to thereby discover for the server 101 via the access points AP. A scanning operation of performing a search for the access points AP includes, for example, an active scan and a passive scan.

An active scan is a scanning operation of transmitting a probe request signal to channels used in the wireless LAN and receiving a probe response signal to thereby search for the access points AP. A passive scan is a scanning operation of receiving from the access points AP, a signal (packet) called a beacon to thereby search for the access points AP.

For example, as a scanning operation of searching for the access points AP, the searching unit 902 may perform both an active scan and a passive scan, or may perform either one of the active scan and the passive scan.

Further, the searching unit 902 searches for a relay terminal Tj configured for short-range wireless communication. Here, the relay terminal Tj is another terminal Tj that relays the delivery app. In particular, for example, the searching unit 902, similarly with respect to the access points AP, scans for a relay terminal Tj to thereby search for a relay terminal Tj configured for short-range wireless communication.

The app acquiring unit 903 acquires a delivery app from the discovered server 101 or relay terminal Tj. The app acquiring unit 903 further acquires an app relay service from the discovered server 101 or relay terminal Ti.

In particular, for example, when an authentication request from the server 101 (or the relay terminal Tj) is received, the app acquiring unit 903 transmits the user information of the terminal Ti to the server 101 (or the relay terminal TJ). The user information, for example, Is input to the authentication screen of the terminal Ti.

When the terminal Ti is authenticated, the app acquiring unit 903 transmits to the server 101 (or the relay terminal Tj), the downloaded-app list 700 and the position information of the terminal Ti. The app acquiring unit 903 receives a delivery app and/or an app relay service from the server 101 (or the relay terminal TJ) and thereby acquires a delivery app and/or an app relay service.

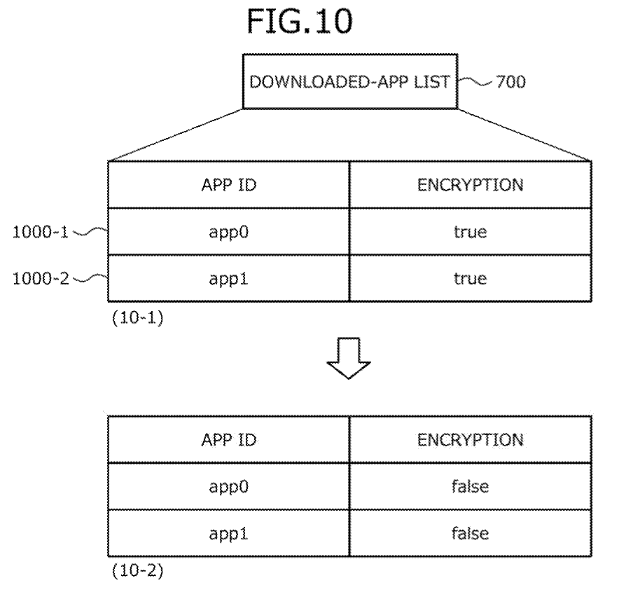

Further, the app acquiring unit 903 updates the downloaded-app list 700 in response to receiving the delivery app or the app relay service. Here, with reference to FIG. 10, an example of updating the downloaded-app list 700 will be described.

FIG. 10 is a diagram depicting an example of updating of the downloaded-app list 700. Here, a case in which an app relay service of the app ID “app0” and the application of the app ID “app1” are acquired from the server 101 will be described as an example.

In this case, the app acquiring unit 903 sets “app0” and “true” in the app ID field and the encryption field of the downloaded-app list 700, respectively. As a result, downloaded app information 1000-1 is stored as a record (refer to (10-1) in FIG. 10).

Further, the app acquiring unit 903 sets “app1” and “true” in the app ID field and the encryption field of the downloaded-app list 700, respectively. As a result, downloaded app information 1000-2 is stored as a record (refer to (10-1) in FIG. 10).

Here, while the app relay service is assumed to be delivered in an encrypted state from the server 101, the app relay service may be delivered in a non-encrypted state. In this case, “false” is set in the encryption field of the downloaded-app list 700.

Further, information included in an app relay service and indicating an area in which a delivery app may be delivered, for example, is stored in a relay app list 1600 depicted in FIG. 16 and described hereinafter. Further, authentication information included in an app relay service and for authenticating another terminal Tj, for example, is stored in a relay terminal authentication DB 1500 depicted in FIG. 15 and described hereinafter.

Here, description related to FIG. 9 is continued. The app executing unit 904 decrypts an acquired delivery app in the delivery area of the delivery app to thereby make the delivery app executable. In particular, for example, when a decryption app is acquired together with the delivery app, the app executing unit 904 invokes the decryption app, acquiring the position information of the terminal Ti.

The app executing unit 904 generates, as a decryption key, a hash value obtained by providing to a hash function, the latitude/longitude information identified from the acquired position information. Next, the app executing unit 904 performs a decryption process for the delivery app using the generated decryption key and when decryption of the delivery app is successful, the app executing unit 904 may execute the decrypted delivery app.

Further, in a case where decryption of the delivery app fails, the app executing unit 904 again acquires the position information of the terminal Ti and repeats the following series of operations. A generation example of a decryption key for decrypting a delivery app will be described hereinafter with reference to FIGS. 11 to 14.

When a decryption key is acquired together with the delivery app, the app executing unit 904 uses the acquired decryption key to decrypt the delivery app. Further, the app executing unit 904 may decrypt the delivery app using a decryption key obtained by transmitting an acquisition request for the decryption key to the server 101.

Further, when the delivery app or the app relay service is decrypted, the app executing unit 904 updates the downloaded-app list 700. For example, in the example (10-2) depicted in FIG. 10, as a result of decryption of the app relay service of the app ID “app0” and the application of the app ID “app1”, “false” is set in the corresponding encryption fields.

Further, the app executing unit 904 invokes the app relay service outside the delivery area. In particular, for example, the app executing unit 904 acquires the position information of the terminal Ti and determines whether the terminal Ti is present outside the delivery area of the delivery app. Information identifying the delivery area, for example, is appended to the delivery app.

When determining that the terminal Ti is outside the delivery area, the app executing unit 904 invokes the app relay service. On the other hand, when determining that the terminal Ti is present in the delivery area, the app executing unit 904 does not invoke the app relay service. As a result, outside the delivery area of the delivery app, the terminal Ti may operate as a relay terminal Ti that relays the delivery app to another terminal Tj.

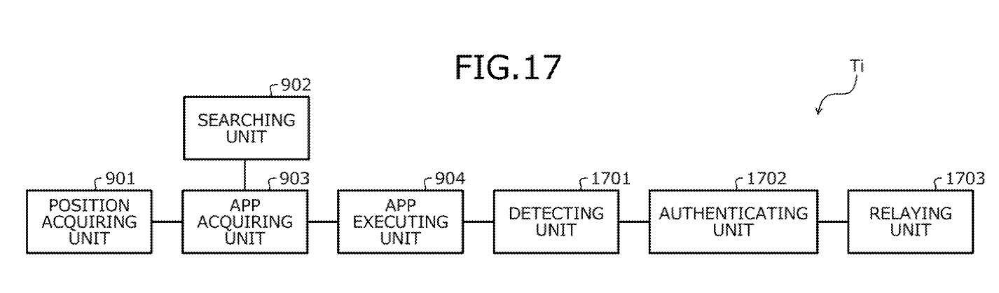

An example of a functional configuration of the relay terminal Ti will be described hereinafter with reference to FIG. 17. Further, in the description above, the app acquiring unit 903 receives the delivery app from the server 101 (or the relay terminal Tj), however, configuration is not limited hereto. For example, the app acquiring unit 903 may receive from the server 101 (or the relay terminal Tj), information indicating a storage location of the delivery app, such a URL. In this case, the app acquiring unit 903 accesses the storage location indicated by received URL information, etc. and thereby acquires the delivery app.

Generation examples of an encryption key for encrypting the delivery app and a decryption key for decrypting the encrypted delivery app will be described.

FIGS. 11, 12, 13, and 14 are diagrams depicting generation examples of an encryption key and a decryption key. Here, first, a generation example of an encryption key for encrypting a delivery app will be described.

In FIG. 11, the delivering unit 803 of the server 101 divides a space into grid areas. Here, the space is a space on the earth and, for example, is a space within a predetermined range from the installation position of the server 101. Further, a grid area is, for example, is a cube or plane having an edge of about several meters to several tens of meters.

In the example depicted in FIG. 11, the delivering unit 803 divides the latitude and the longitude in units of seconds (°) and thereby divides the space into grid areas (for example, grid areas G1 to G9).

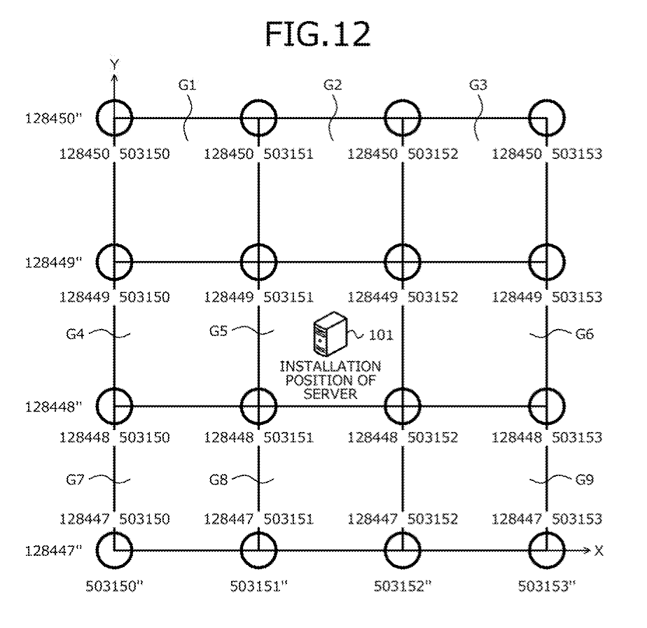

In FIG. 12, the delivering unit 803 converts the latitude and longitude of an upper left vertex of a grid area that corresponds to a delivery area into units of seconds (°) and concatenates the converted values. Here, a grid area corresponding to a delivery area may be, for example, a grid area that includes the installation position of the server 101 or may be a grid area that includes the installation position of an access point AP that corresponds to a delivery area.

While a grid area that corresponds to a delivery area may preferably match a rectangular region identified from coordinate positions of vertices of a diagonal of a delivery area indicated in the delivery app list 230, the grid area needs not exactly match the coordinate positions. For example, a grid area that corresponds to a delivery area may be a grid area that includes a rectangular region identified from coordinate positions of vertices of a diagonal of a delivery area indicated in the delivery app list 230.

In the example depicted in FIG. 12, a grid area that corresponds to a delivery area is assumed as the grid area G5 that includes the installation position of the server 101. In this case, the delivering unit 803 converts the latitude 35° 40′49″ and the longitude 139°45′51″ of the upper left vertex of the grid area G5 into a unit of seconds (″) to obtain and concatenate the latitude 128449″ and the longitude 503151″.

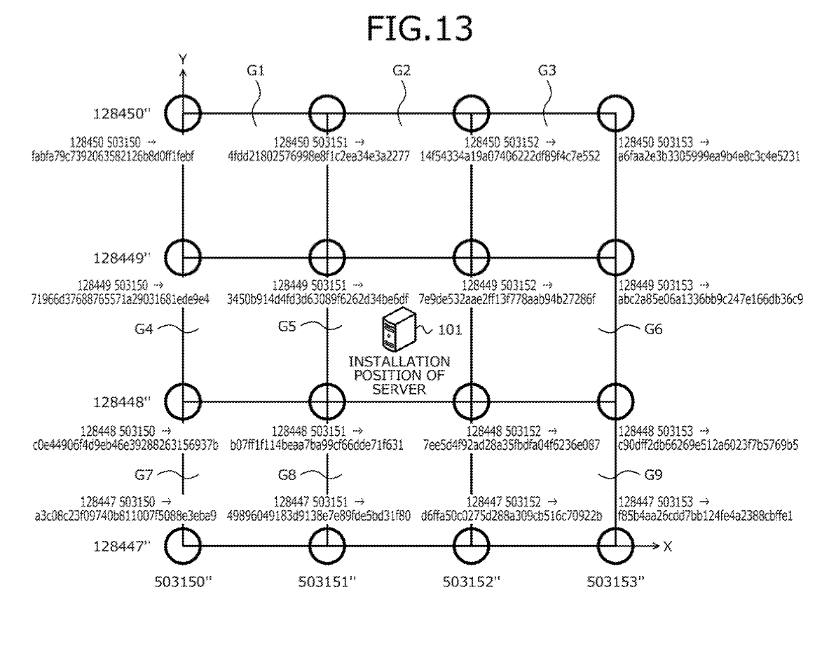

In FIG. 13, the delivering unit 803 applies a hash function to the value obtained by concatenating the latitude and longitude (expressed in seconds) of the upper left vertex of the grid area that corresponds to a delivery area. In the example depicted in FIG. 13, the delivering unit 803 acquires a hash value by providing to Message Digest Algorithm 5 (MD5), the value obtained by concatenating the latitude and longitude (expressed in seconds) of the upper left vertex of the grid area G5.

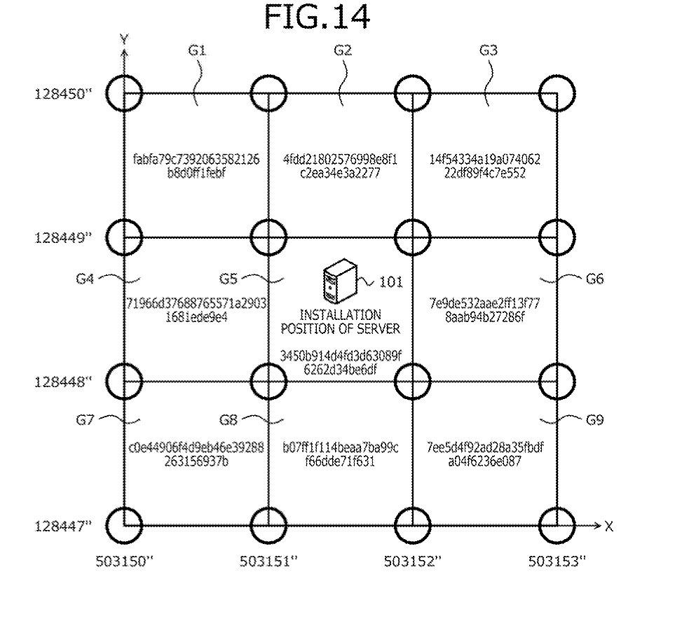

In FIG. 14, the delivering unit 803 uses, as an encryption key, the hash value obtained by the hash function. In the example depicted in FIG. 14, the delivering unit 803 uses the hash value 3450b914d4fd3d63089f6262d34be6df of the grid area G5 as an encryption key. As a result, the delivering unit 803 may generate an encryption key for encrypting a delivery app to become executable in the grid area G5 as the delivery area.

A generation example of a decryption key for decrypting an encrypted delivery app will be described.

In FIG. 11, the app executing unit 904 of a terminal Ti divides a space into grid areas. Here, the space, for example, is a space within a predetermined range from the current position of the terminal Ti. A reference point and grid area size used when the app executing unit 904 divides a space are the same as those when the delivering unit 803 of the server 101 divides a space.

In the example depicted in FIG. 11, the app executing unit 904 divides the latitude and the longitude in units of seconds (″) and thereby divides the space into grid areas (for example, grid areas G1 to G9).

In FIG. 12, the app executing unit 904 converts the latitude and longitude of an upper left vertex of a grid area that corresponds to the position of the terminal Ti into units of seconds (°) and concatenates the converted values. In the example depicted in FIG. 12, the grid area in which the terminal Ti is positioned is assumed to be the grid area G1. In this case, the app executing unit 904 converts the latitude 35° 40′50″ and the longitude 13945′50″ of the upper left vertex of the grid area G1 into a unit of seconds (°) to obtain and concatenate the latitude 128450″ and the longitude 503150″.

In FIG. 13, the app executing unit 90 applies a hash function to the value obtained by concatenating the latitude and longitude (expressed in seconds) of the upper left vertex of the grid area in which the terminal Ti is positioned. In the example depicted in FIG. 13, the app executing unit 904 acquires a hash value by providing to MD5, the value obtained by concatenating the latitude and longitude (expressed in seconds) of the upper left vertex of the grid area G1.

In FIG. 14, the app executing unit 904 uses, as a decryption key, the hash value of the grid area in which the terminal Ti is positioned. In the example depicted in FIG. 14, the app executing unit 904 uses the hash value fabfa79c7392063582126b8d0ff1febf of the grid area G1 in which the terminal Ti is positioned, as a decryption key. However, in this case, since the encryption key and the decryption key do not match, the delivery app is not decryptable.

In other words, the app executing unit 904 may decrypt the delivery app by the decryption key generated by the described algorithm only when the terminal Ti is positioned in the grid area G5 that corresponds to the delivery area.

Contents of the relay terminal authentication DB 1500 retained by a relay terminal Ti will be described. The relay terminal authentication DB 1500 is implemented by, for example, the memory 402 depicted in FIG. 4.

FIG. 15 is a diagram depicting an example of the contents of the relay terminal authentication DB 1500. In FIG. 15, the relay terminal authentication DB 1500 has fields for user IDs and passwords, and by a setting of information into the fields, stores authentication information (for example, authentication information 1500-1, 1500-2) as records. In the example depicted in FIG. 15, while the authentication information is described in plain text, for example, the authentication information is stored in the relay terminal authentication DB 1500 in an encrypted state.

The user ID is an identifier that identifies the user of another terminal Tj. The password is the password of the user of the terminal Tj. The user ID and password, for example, are used in authenticating the user. For example, the authentication information 1500-1 indicates a user ID “bob” and a password “pwd1”.

Contents of the relay app list 1600 retained by the relay terminal Ti will be described. In the relay app list 1600, information of a delivery app delivered from the server 101 is registered. The relay app list 1600 is implemented by, for example, the memory 402 depicted in FIG. 4.

FIG. 16 is a diagram depicting an example of the contents of the relay app list 1600. In FIG. 16, the relay app list 1600 has fields for app IDs, relay areas, and encryption, and by a setting of information into the fields, stores relay app information (for example, relay app information 1600-1, 1600-2) as records.

Here, an app ID is an identifier that identifies an application to be relayed, i.e., a delivery app delivered from the server 101. The relay area is information identifying an area in which the application to be relayed. Here, the relay area indicates coordinate positions of vertices of a diagonal of a rectangular region on the earth. Further, an area larger than a “delivery area” described above may be set as the relay area.

Encryption indicates whether the application to be relayed is encrypted. For example, the relay app information 1600-1 indicates an app ID “app1” and a relay area “(x5, y5), (x6, y6)”.

FIG. 17 is a block diagram of an example of a functional configuration of the relay terminal Ti according to the first embodiment. In FIG. 17, the relay terminal Ti is configured including the position acquiring unit 901, the searching unit 902, the app acquiring unit 903, the app executing unit 904, a detecting unit 1701, an authenticating unit 1702, and a relaying unit 1703. The position acquiring unit 901 to the app executing unit 904 and the detecting unit 1701 to the relaying unit 1703 are functions constituting a control unit and, for example, are implemented by executing on the CPU 401, a program stored in the memory 402 depicted in FIG. 4, or by the public network I/F 405 or the short-range wireless I/F 406. Processing results of the functional units are stored to, for example, the memory 402. Functional units identical to those of the terminal Ti depicted in FIG. 9 are given the same reference numerals used in FIG.) and description thereof is omitted hereinafter.

The detecting unit 1701 detects another terminal Tj configured for short-range wireless communication. In particular, for example, the detecting unit 1701 may be configured to transmit a signal (packet) called a beacon and wait for a response to the signal to thereby detect another terminal Tj configured for short-range wireless communication.

The authenticating unit 1702, when another terminal Tj configured for short-range wireless communication is detected, performs an authentication process for the detected terminal Tj. In particular, for example, first, when the terminal Tj configured for short-range wireless communication is detected, the authenticating unit 1702 connects to the detected terminal Tj and transmits an authentication request. Here, the authentication request requests authentication of whether the user of the terminal Tj is a valid user of the application delivery system 200.

Next, the authenticating unit 1702 receives user information from the terminal Tj. Here, the user information, for example, includes a user ID and password, etc. input to an authentication screen of the terminal Tj. The authenticating unit 1702 performs an authentication process for the terminal Tj based on the user information received from the terminal Tj.

In more detail, for example, the authenticating unit 1702 decodes the received user information and from the relay terminal authentication DB 1500 (for example, refer to FIG. 15), identifies a password that corresponds to the user ID included in the user information. The authenticating unit 1702 compares the identified password and the password included in the user information.

When the passwords match, the authenticating unit 1702 authenticates the terminal Tj (authentication successful). On the other hand, passwords do not match, the authenticating unit 1702 does not authenticate the terminal Tj (authentication failed). Further, the authenticating unit 1702 does not authenticate the terminal Tj (authentication failed), when being unable to identify in the relay terminal authentication DB 1500, a password that corresponds to the user ID included in the user information.

The relaying unit 1703, when the terminal Tj is authenticated, determines whether the terminal Tj is present in the relay area of the application to be relayed. Here, the application to be relayed is a delivery app delivered from the server 101. In the description hereinafter, an application to be relayed may be indicated as “delivery app”.

In particular, for example, first, when the terminal Tj is authenticated, the relaying unit 1703 receives position information and the downloaded-app list 700 from the terminal Tj. Next, the relaying unit 1703, for example, refers to the relay app list 1600 depicted in FIG. 16 and identifies the relay area of the delivery app.

The relaying unit 1703 determines whether the terminal Tj is present in the relay area of the delivery app, based on the received position information of the terminal Tj. However, when a portion of the relay area of the delivery app overlaps the delivery area of the delivery app, the relaying unit 1703 determines whether the terminal Tj is present in the relay area of the delivery app and is outside the delivery area of the delivery app.

When plural relay areas are identified from the relay app list 1600, the relaying unit 1703 determines for each of the relay areas, whether the terminal Tj is present in the relay area.

Further, when the terminal Tj is present in the relay area, the relaying unit 1703 determines whether the delivery app is included in the received downloaded-app list 700. When the delivery app is not included in the downloaded-app list 700, the relaying unit 1703 transmits the delivery app to the terminal Tj.

At this time, the relaying unit 1703 may transmit a decryption app together with the delivery app to the terminal Ti. Further, the relaying unit 1703 may transmit an app relay service together with the delivery app to the terminal Tj. However, when the app relay service is included in the downloaded-app list 700, the relaying unit 1703 does not transmit the app relay service to the terminal Tj.

In the description above, the relaying unit 1703 transmits the delivery app to the terminal Tj, however, configuration is not limited hereto. For example, the relaying unit 1703 may transmit to the terminal Tj, information indicating a storage location of the delivery app such as a URL.

A procedure of an application delivery process of the server 101 according to the first embodiment will be described.

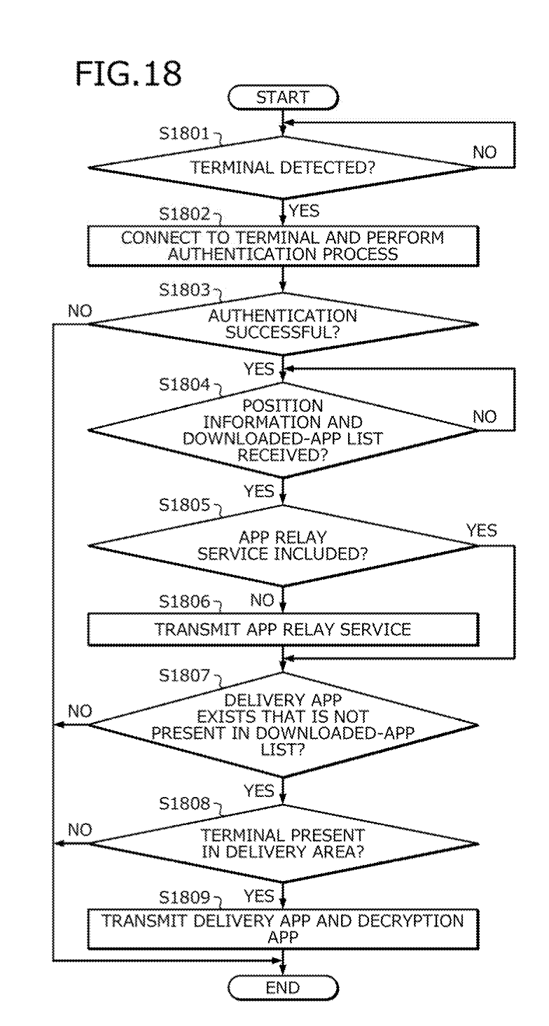

FIG. 18 is a flowchart of an example of a procedure of the application delivery process by the server 101 according to the first embodiment. In the flowchart depicted in FIG. 18, first, the server 101 determines whether a terminal Ti configured to perform wireless communication has been detected via the access points AP (step S1801).

Here, the server 101 waits for detection of a terminal Ti (step S1801: NO) and when a terminal Ti has been detected (step S1801: YES), connects to the detected terminal Ti and performs an authentication process (step S1802).

The server 101 determines whether authentication of the terminal Ti is successful (step S1803).

When authentication of the terminal T1 fails (step S1803: NO), the server 101 ends a series of operations according to the flowchart.

On the other hand, when authentication of the terminal Ti is successful (step S1803: YES), the server 101 determines whether position information and the downloaded-app list 700 has been received from the terminal Ti (step S1804). Here, the server 101 waits for receipt of the position information and the downloaded-app list 700 from the terminal Ti (step S1804: NO).

When the position information and the downloaded-app list 700 have been received from the terminal Ti (step S1804: YES), the server 101 determines whether an app relay service is included in the received downloaded-app list 700 (step S1805), When the app relay service is included (step S1805: YES), the server 101 transitions to step S1807.

On the other hand, when the app relay service is not included (step S1805: NO), the server 101 transmits the app relay service to the terminal Ti (step S1806). Next, the server 101 refers to the delivery app list 230 and determines whether a delivery app exists that is not present in the received downloaded-app list 700 (step S1807).

When no delivery app exists that is not present in the received downloaded-app list 700 (step S1807: NO), the server 101 ends a series of operations according to the flowchart.

On the other hand, when a delivery app exists that is not present in the downloaded-app list 700 (step S1807: YES), the server 101 refers to the delivery app list 230 and based on the received position information of the terminal Ti, determines whether the terminal Ti is present in the delivery area of the delivery app (step S1808).

When the terminal Ti is not present in the delivery area (step S1808: NO), the server 101 ends a series of operations according to the flowchart.

On the other hand, when the terminal Ti is present in the delivery area (step S1808: YES), the server 101 transmits the delivery app and a decryption app to the terminal Ti (step S1809), ending a series of operations according to the flowchart.

As a result, the server 101 may deliver to a terminal Ti present in a delivery area, a delivery app that is executable in the delivery area and an app relay service.

At step S1806, the server 101 may transmit the app relay service to, for example, one terminal among plural terminals for which authentication is successful (for example, 1 terminal among 3 terminals). Further, the server 101 may transmit the app relay service to a terminal Ti when the density of terminals in a delivery area is a threshold or higher. As a result, the number of terminals to which an app relay service is delivered may be limited.

A procedure of an application execution process of the terminal Ti according to the first embodiment will be described.

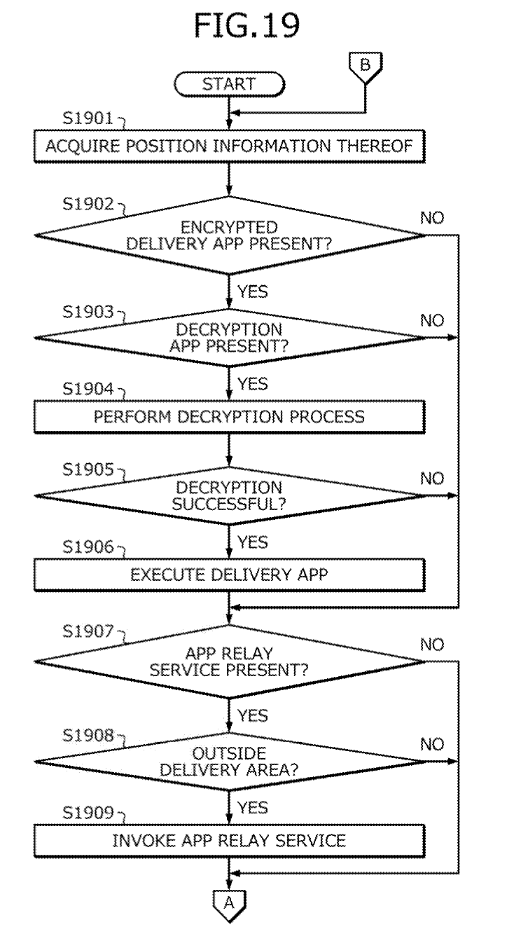

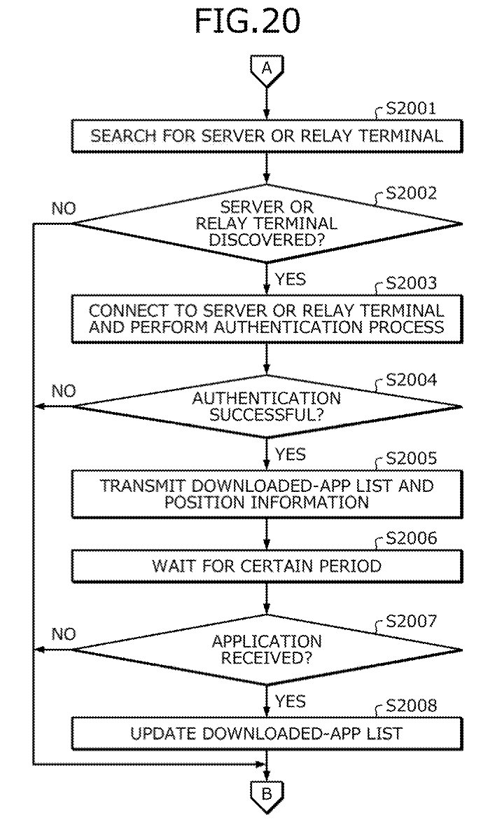

FIGS. 19 and 20 are flowcharts of an example of a procedure of the application execution process by the terminal Ti according to the first embodiment. In the flowchart depicted in FIG. 19, first, the terminal Ti acquires position information of the terminal Ti (step S1901).

Next, the terminal Ti refers to the downloaded-app list 700 and determines whether an encrypted delivery app is included (step S1902). When the encrypted delivery app is not included (step S1902: NO), the terminal Ti transitions to step S1907.

On the other hand, when the encrypted delivery app is included (step S1902: YES), the terminal Ti determines whether a decryption app of the encrypted delivery app is included (step S1903). When the decryption app is not included (step S1903: NO), the terminal Ti transitions to step S1907.

On the other hand, when the decryption app is included (step S1903: YES), the terminal Ti invokes the decryption app and based on the acquired position information of the terminal Ti, performs a decryption process for the encrypted delivery app (step S1904). The terminal Ti determines whether decryption of the encrypted delivery app is successful (step S1905).

When decryption of the delivery app fails (step S1905: NO), the terminal Ti transitions to step S1907. On the other hand, when decryption of the delivery app is successful (step S1905: YES), the terminal Ti executes the decrypted delivery app (step S1906).

Next, the terminal Ti refers to the downloaded-app list 700 and determines whether an app relay service is included (step S1907). When no app relay service is included (step S1907: NO), the terminal Ti transitions to step S2001 depicted in FIG. 20.

On the other hand, when the app relay service is included (step S1907: YES), the terminal Ti determines whether the terminal Ti is outside the delivery area of the delivery app, based on the acquired position information of the terminal Ti (step S1908). When the terminal Ti is present in the delivery area (step S1908: NO), the terminal Ti transitions to step S2001 depicted in FIG. 20.

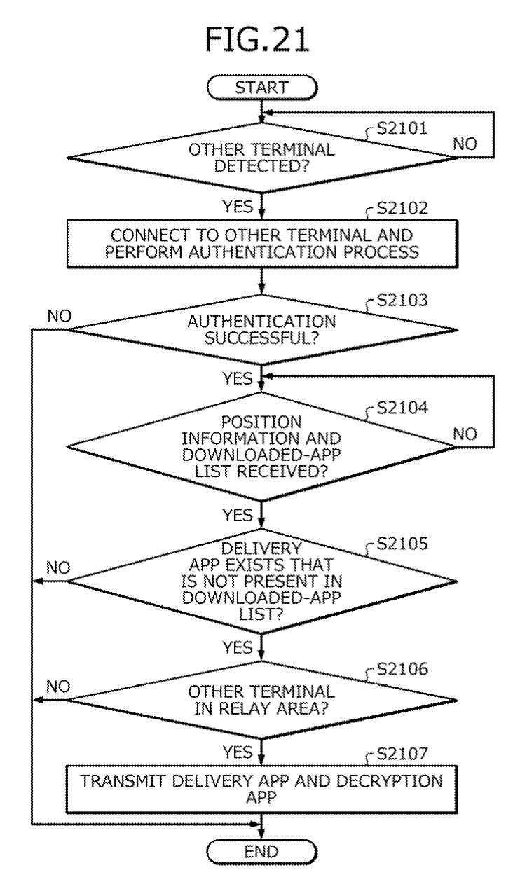

On the other hand, when the terminal Ti is outside the delivery area (step S1908: YES), the terminal Ti invokes the app relay service (step S1909), and transitions to step S2001 depicted in FIG. 20. As a result, the terminal Ti may operate as the relay terminal Ti that relays the delivery app to another terminal Tj. A procedure of an application relay process of the relay terminal Ti will be described with reference to FIG. 21.

In the flowchart depicted in FIG. 20, first, the terminal Ti searches for the server 101 or the relay terminal Tj (step S2001). The terminal Ti determines whether the server 101 or the relay terminal Tj has been discovered (step S2002). When neither the server 101 nor the relay terminal Tj has been discovered (step S2002: NO), terminal Ti returns to step S1901 depicted in FIG. 19.

On the other hand, when the server 101 or the relay terminal Tj has been discovered (step S2002: YES), terminal Ti connects to the discovered server 101 or the discovered relay terminal Tj and performs an authentication process (step S2003). The terminal Ti determines whether authentication of the terminal Ti is successful (step S2004).

When authentication of the terminal Ti fails (step S2004: NO), the terminal Ti returns to step S1901 depicted in FIG. 19. On the other hand, when authentication of the terminal Ti is successful (step S2004: YES), the terminal Ti transmits the downloaded-app list 700 and the position information of the terminal Ti to the server 101 (step S2005).

Next, the terminal Ti waits for certain period of time for receipt of an application from the server 101 (step S2006). The certain period of time, for example, is a period of about several seconds to several tens of seconds. The terminal Ti determines whether at least an application of any one of a delivery app, a decryption app, and an app relay service has been received from the server 101 (step S2007).

When no application has been received (step S2007: NO), the terminal TI transitions to step S1901 depicted in FIG. 19.

On the other hand, when at least any one application has been received (step S2007: YES), the terminal Ti updates the downloaded-app list 700 (step S2008), and returns to step S1901 depicted in FIG. 19. Here, when the app relay service has been invoked, the terminal Ti also updates the relay app list 1600.

As a result, the terminal Ti may decrypt and execute a delivery app in the delivery area. Further, the terminal Ti may invoke an app relay service outside the delivery area and operate as the relay terminal Ti that relays the delivery app to another terminal Tj.

At step S1903 depicted in FIG. 19, when the decryption app is not included (step S1903: NO), the terminal Ti may transmit to the server 101, an acquisition request for the decryption key of the encrypted delivery app. As a result, the terminal Ti may acquire from the server 101, the decryption key for decrypting the encrypted delivery app and make the delivery app executable.

A procedure of the application relay process of the relay terminal Ti according to the first embodiment will be described.

FIG. 21 is a flowchart of an example of a procedure of the application relay process by the relay terminal Ti according to the first embodiment. In the flowchart depicted in FIG. 21, first, the relay terminal Ti determines whether another terminal Tj configured for short-range wireless communication has been detected via the access points AP (step S2101).

Here, the relay terminal Ti waits for detection of another terminal Tj (step S2101: NO) and when another terminal Tj is detected (step S2101: YES), connects to the detected terminal Tj and performs an authentication process (step S2102). The relay terminal Ti determines whether authentication of the terminal Tj is successful (step S2103).

When authentication of the terminal Tj fails (step S2103: NO), the relay terminal Ti ends a series of operations according to the flowchart.

On the other hand, when authentication of the terminal Tj is successful (step S2103: YES), the relay terminal Ti determines whether position information and the downloaded-app list 700 has been received from the terminal TJ (step S2104). Here, the relay terminal T1 waits for receipt of the position information and the downloaded-app list 700 from the terminal Tj (step S2104: NO).

When position information and the downloaded-app list 700 has been received from the terminal Tj (step S2104: YES), the relay terminal Ti refers to the relay app list 1600 and determines whether a delivery app exists that is not present in the received downloaded-app list 700 (step S2105).

When no delivery app exists that is not present in the downloaded-app list 700 (step S2105: NO), the relay terminal Ti ends a series of operations according to the flowchart.

On the other hand, when a delivery app exists that is not present in the downloaded-app list 700 (step S2105: YES), the relay terminal Ti refers to the relay app list 1600 and determines whether the terminal Tj is present in the relay area of the delivery app, based on the received position information of the terminal Tj (step S2106).

When the terminal TJ is not present in the relay area (step S2106: NO), the relay terminal Ti ends a series of operations according to the flowchart.

On the other hand, when the terminal Tj is present in the relay area (step S2106: YES), the relay terminal Ti transmits the delivery app and the decryption app to the terminal Ti (step S2107), ending a series of operations according to the flowchart.

As a result, the relay terminal Ti may deliver to another terminal Tj configured for short-range wireless communication and present in the relay area, a delivery app executable in the delivery area.

As described above, the server 101 according to the first embodiment enables a delivery app and an app relay service to be delivered to a terminal Ti present in a delivery area. Further, the terminal Ti according to the first embodiment, when receiving a delivery app from the server 101, may decrypt the delivery app in the delivery area, making the delivery app executable.

Further, the terminal Ti, when receiving an app relay service from the server 101, may invoke the app relay service outside the delivery area and operate as a relay terminal Ti that relays the delivery app to another terminal TJ. Further, the relay terminal Ti according to the first embodiment may detect another terminal Tj present in the relay area and deliver to the terminal Tj, a delivery app executable in a delivery area.

Further, the server 101 may perform an authentication process for a terminal Ti in response to detection of the terminal Ti present in the delivery area and when the terminal Ti is authenticated, the server 101 may transmit a delivery app and an app relay service to terminal Ti. As a result, delivery of a delivery app and an app relay service from the server 101 may be limited to a valid user of the application delivery system 200.

Further, the relay terminal Ti may perform an authentication process for another terminal Tj in response to detection of the terminal Tj and when the terminal Tj is authenticated, may transmit a delivery app to the terminal Tj. As a result, delivery of a delivery app from the relay terminal Ti may be limited to a valid user of the application delivery system 200.

The server 101 may encrypt a delivery app using an encryption key generated using position information that corresponds to the delivery area. Further, the server 101 may transmit to a terminal Ti, the delivery app and the decryption app of the delivery app for performing a decryption process of the delivery app by the decryption key generated using the position information of the terminal Ti. As a result, control may be performed such that a delivery app is decrypted and executable in the delivery area without distribution of the decryption key to terminals Ti.

Thus, the application delivery system 200 according to the first embodiment enables the load for delivering a delivery app to be distributed to the server 101 and a relay terminal Ti whereby a concentration of the load at the server 101 may be suppressed. As a result, a delivery app may be distributed quickly to users in a service area (delivery area), enabling delays in the start of a service to be prevented. Further, since delivery of a delivery app by the relay terminal Ti is performed outside the service area, a concentration of load on the network in the service area may be prevented.

The application delivery method according to a second embodiment will be described. Parts identical to those described in the first embodiment are given the same reference numerals used in the first embodiment and description thereof is omitted hereinafter.

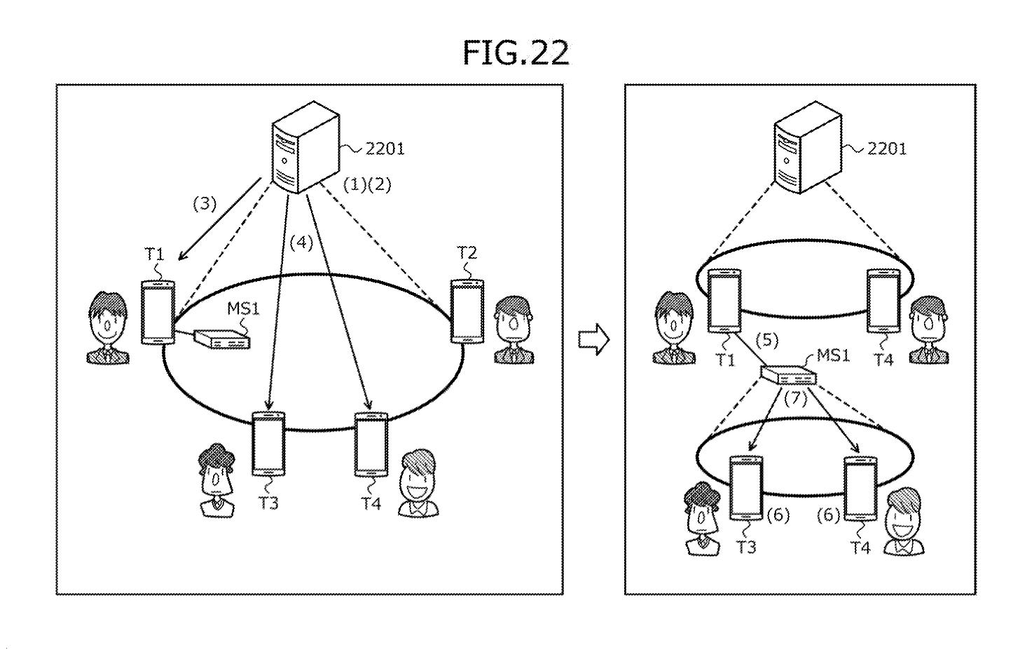

FIG. 22 is a diagram depicting an example of the application delivery method according to the second embodiment. In FIG. 22, the server 2201 is a computer configured to deliver an application. Further, a terminal T (for example, terminals T1 to T4) is a computer configured to perform wireless communication and, for example, is a smartphone, a mobile telephone, a tablet-type personal computer (PC), etc.

The server 2201 is installed at, for example, a store, a school, an event venue, etc. and delivers an application to the terminal apparatus T of a student registered at the school, a visitor of the store or the event venue, etc. For example, when the server 2201 is installed at a store, the application to be delivered is a coupon app that may be used at the store.

Further, for example, when the server 2201 is installed at a school, the application to be delivered is a teaching material app used in a lesson, etc. For example, when the server 2201 is installed at an event venue of a concert, a music festival, etc., the application to be delivered is a music player app, etc.

In other words, installation of the server 2201 at a store, a school, an event venue, etc., enables a service related to the location to be provided to a user in a local area near the store or the event venue, a classroom in the school, etc. On the other hand, when access to the server 2201 installed at the store, the school, etc. suddenly increases, load for delivering the application concentrates.

Thus, in the second embodiment, a method of suppressing load concentration at the server 2201 by a distribution of the load for delivering an application by using a mobile server MS of a user will be described. Hereinafter, an example of a process by the server 2201 and the terminals T1 to T4 will be described assuming a case in which the terminals T1 to T4 are connected to the server 2201.

(1) The server 2201 extracts from among plural connected terminals T, a first terminal associated with the mobile server MS. Here, the mobile server MS is, for example, a portable computer and has a function of delivering an application. However, this function of the mobile server MS may be implemented by an application executed by the terminal T.

In the example depicted in FIG. 1, a case is assumed in which the user of the terminal T1 maintains the terminal Ti and a mobile server MS1 as a set where the terminal T1 and the mobile server MS1 are connected (paired) by a wireless LAN, Bluetooth, etc. In this case, the server 2201 extracts from among the connected terminals T1 to T4 as the first terminal, the terminal Ti connected to a mobile server MS1.

(2) The server 2201 extracts from among the connected plural terminals T, a second terminal that is to switch a connection destination. In particular, for example, the server 2201 may extract from among the connected terminals Ti to T4 as a second terminal, at least any one of the terminals T different from the terminal T1 that is connected to the mobile server MS1. In the example depicted in FIG. 22, the terminals T3, T4 are assumed to be extracted as second terminals.

(3) The server 2201 transmits to the extracted first terminal, an application and an operation instruction for the mobile server MS. Here, the application is an application to be delivered and is, for example, a coupon app, a teaching material app, a music player app, etc.

Further, the operation instruction for the mobile server MS instructs the first terminal to enable a function of the mobile server MS to deliver the application from the mobile server MS to the second terminals. The operation instruction for the mobile server MS includes, for example, network configuration information for the mobile server MS to connect to the second terminals.

Here, the mobile server MS and the second terminals are connected by, for example, a wireless LAN. In this case, the network configuration information includes, for example, information such as a Service Set Identifier (SSID) for building a network of the wireless LAN, a security type, a password, a compliance standard, and a channel.

The SSID is an identifier of the access point implemented by the mobile server MS when the mobile server MS operates as an access point of the wireless LAN. Further, the security type, the password, the compliance standard, and the channel represent the encryption type, the password, the compliance standard, and the channel used in communication between the mobile server MS and the second terminals.

In the example depicted in FIG. 22, the server 2201 transmits to the terminal T1 that has been extracted as the first terminal, an application and an operation instruction for the mobile server MS1.

(4) The server 2201 transmits to the extracted second terminals, a switching instruction to switch the connection destination to the mobile server MS. The switching instruction includes network information used in communication with the mobile server MS. The network information includes, for example, a SSID and a password, etc.

In the example depicted in FIG. 22, the server 2201 transmits to the terminals T3, T4 extracted as second terminals, a switching instruction to switch the connection destination to the mobile server MS.

(5) The terminal T (first terminal), in response to receiving the operation instruction for the mobile server MS from the server 2201, enables a function of the mobile server MS. In particular, for example, the terminal T (first terminal) transmits the network configuration information included in the operation instruction to the mobile server MS and instructs the mobile server MS to perform network configuration based on the network configuration Information. Further, the terminal T (first terminal) transmits to the mobile server MS, the application received from the server 2201.

In the example depicted in FIG. 22, the terminal T1, for example, in response to receiving the operation instruction for the mobile server MS, uploads the application received from the server 2201 to the mobile server MS1, enabling a function of the mobile server MS1.

(6) Each of the terminals T (second terminals), in response to receiving the switching instruction from the server 2201, switches the connection destination from the server 2201 to the mobile server MS. In the example depicted in FIG. 22, the terminals T3, T4, for example, in response to receiving the switching instruction from the server 2201, terminate the connection to the server 2201. Subsequently, the terminals T3, T4 connect to the mobile server MS1, based on the network information included in the switching instruction from the server 2201.

(7) The mobile server MS, in response to the connection of the second terminals, transmits the application received from the first terminal to the second terminals. In the example depicted in FIG. 22, the mobile server MS1, in response to the connection of the terminals T3, T4, transmits to the terminals T3, T4, respectively, the application downloaded from the terminal T1.

In this manner, the server 2201 may extract from among the connected plural terminals T, a first terminal associated with the mobile server MS and transmit an application to be delivered and an operation instruction for the mobile server MS. Further, the server 2201 may extract from among the connected plural terminals T, a second terminal that is to switch the connection destination thereof and the server 2201 may transmit a switching instruction instructing the second terminal to switch the connection destination to the mobile server MS.

As a result, a function of the mobile server MS paired with a first terminal may be enabled whereby an application may be delivered from the mobile server MS to a second terminal and a concentration of load for delivering the application may be suppressed at the server 2201.

The terminals T3, T4 may terminate the connection to the mobile server MS1 and reconnect to the server 2201 when reception of the application from the mobile server MS1 is completed. As a result, the server 2201 may start a service using the application with respect to the terminals T3, T4.

An example of system configuration of an application delivery system 2300 according to the second embodiment will be described.

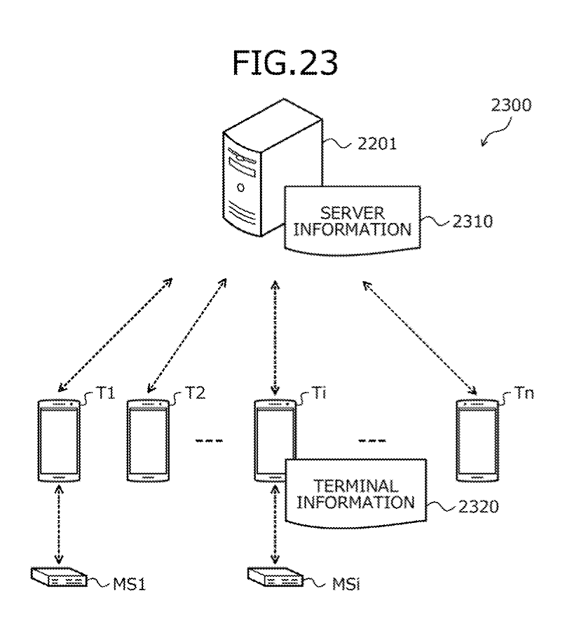

FIG. 23 is a diagram depicting a system configuration example of the application delivery system 2300. In FIG. 23, the application delivery system 2300 includes the server 2201, the terminals T1 to Tn (n: a natural number of 2 or more), and one or more of the mobile servers MS (for example, the mobile server MS1).

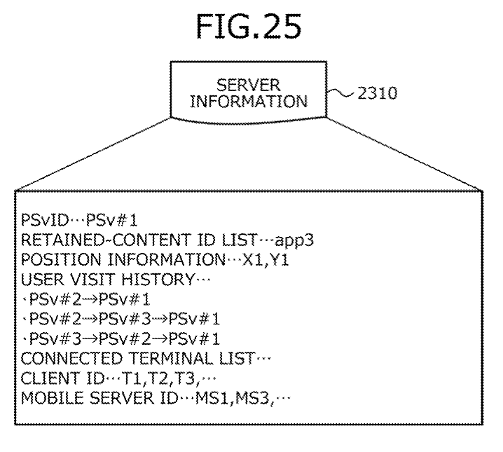

Here, the server 2201 has server information 2310. A detailed example of the server information 2310 will be described hereinafter with reference to FIG. 25. The server 220 has, for example, a built-in wireless LAN access point and may be wirelessly connected to a terminal Ti (i=1, 2 . . . , n) via the access point.

Although not depicted, the server 2201 may have, for example, the authentication DB 220 and the delivery app list 230 like those depicted in FIGS. 5 and 6.

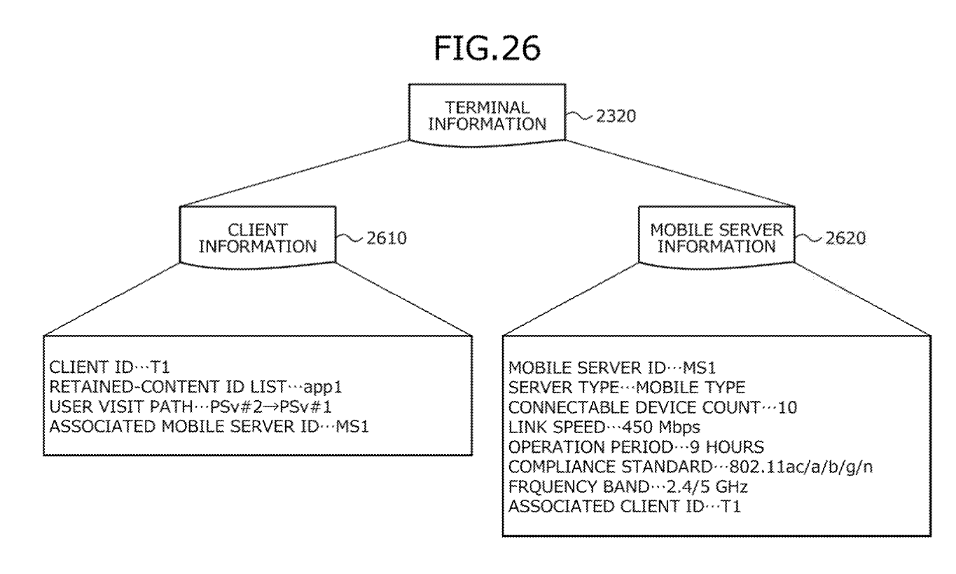

The terminals T1 to Tn, for example, may wirelessly communicate with the server 2201, via the access point, within a communication range of the access point built into the server 2201. Each of the terminals T1 to Tn has terminal information 2320. A detailed example of the terminal information 2320 will be described hereinafter with reference to FIG. 26.

The mobile server MS is a portable computer maintained as a set with the terminal T and, for example, is connected to the terminal T by a wireless LAN (or Bluetooth). However, among users, some users have a mobile server MS and some users do not have a mobile server MS.

In the example depicted in FIG. 23, for example, the user of the terminal T1 has the mobile server MS1 as a set with the terminal T1 while the user of the terminal T2 does not have a mobile server MS. In the description hereinafter, as depicted in FIG. 23, a mobile server MS maintained as a set with a terminal Ti and connected to the terminal Ti may be indicated as “mobile server MSi”.

In the description above, while a case where the wireless LAN access point is built into the server 2201 has been described as an example, configuration is not limited hereto. For example, like the application delivery system 200 depicted in FIG. 2, plural access points AP connected to the server 2201 may be installed at plural locations, and the server 2201 and a terminal Ti may communicate via the access points AP.

An example of hardware configuration of the mobile server MSi will be described. Since the example of hardware configuration of the server 2201 is identical to the example of hardware configuration of the server 101 depicted in FIG. 3, depiction and description thereof are omitted herein. Further, since an example of hardware configuration of a terminal Ti is identical to the example of hardware configuration of the terminal Ti depicted in FIG. 4, depiction and description thereof are omitted herein.

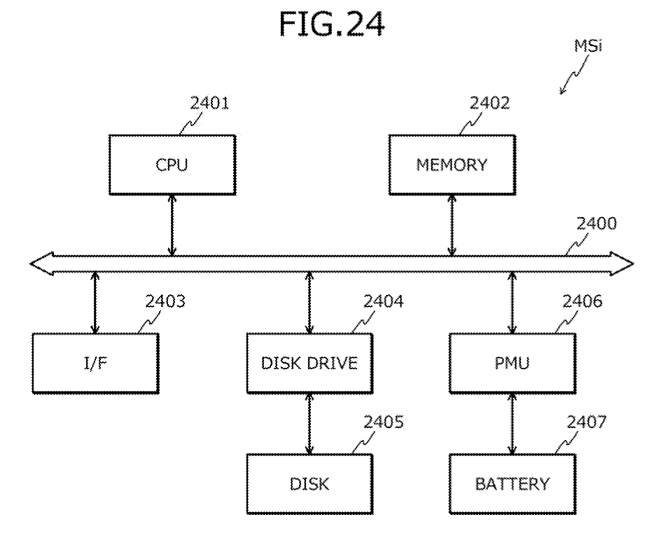

FIG. 24 is a block diagram of an example of hardware configuration of a mobile server MSi. In FIG. 24, the mobile server MSi has a CPU 2401, a memory 2402, an I/F 2403, a disk drive 2404, a disk 2405, a power management unit (PMU) 2406, and a battery 2407, respectively connected by a bus 2400.

Here, the CPU 2401 governs overall control of the mobile server MS1. The memory 2402 includes, for example, ROM, RAM, and flash ROM. In particular, for example, the flash ROM and the ROM store various types of programs; and the RAM is used as a work area of the CPU 2401. A program stored in the memory 2402 is loaded onto the CPU 2401 whereby an encoded process is executed by the CPU 2401.

The I/F 2403 is connected to a short-range wireless network through a communications line and is connected to another apparatus via the short-range wireless network. The I/F 2403 administers an internal interface with the short-range wireless network and controls the input and output of data from another apparatus.

The disk drive 2404, under the control of the CPU 2401, controls the reading and writing of data with respect to the disk 2405. The disk 2405 stores data written thereto under the control of the disk drive 2404. The PMU 2406 controls the supply of electrical power stored by the battery 2407, to components of the mobile server MSi as a driving power source.

In addition to the configuration described above, the mobile server MSi may further have, for example, a SSD, an input pad, a display, etc.

A detailed example of the server information 2310 retained by the server 2201 will be described. The server information 2310 is stored in, for example, a storage apparatus such as the memory 302 or the disk 305 depicted in FIG. 3 or the like.

FIG. 25 is a diagram depicting a detailed example of the server information 2310. In FIG. 25, the server information 2310 includes a PSvID, a retained-content ID list, position information, a user visit history, and a connected terminal list.

Here, the PSvID is an identifier identifying the server 2201. The PSvID of the server 2201 is “PSv#1”. The retained-content ID list is an identifier (for example, app3) identifying an application retained by the server 2201. The position information indicates coordinate positions (latitude, longitude) of a point where the server 2201 is installed.

The user visit history indicates other servers to which a terminal Ti connected before connecting to the server 2201. For example, “PSv#2→PSv#1” indicates that before connecting to the server 2201, the terminal Ti was connected to another server identified by a PSvID “PSv#2”. Other servers Installed near the server 2201, for example, may be known from the user visit history.

The connected terminal list indicates as a list, client IDs (for example, T1, T2, T3) identifying each terminal Ti connected to the server 2201 and mobile server IDs (for example, MS1, MS3) identifying the mobile server MSi connected to each terminal Ti connected to the server 2201.

A detailed example of the terminal information 2320 retained by a terminal Ti will be described. The terminal information 2320, for example, is stored in the memory 402 depicted in FIG. 4. Here, taking the terminal T1 as an example, a detailed example of the terminal information 2320 retained by the terminal T1 will be described.

FIG. 26 is a diagram depicting a detailed example of the terminal information 2320. In FIG. 26, the terminal information 2320 includes client information 2610 and mobile server information 2620.

The client information 2610 includes a client ID, a retained-content ID list, a user visit path, and an associated mobile server ID. Here, the client ID is an identifier identifying a terminal Ti (in the example depicted in FIG. 26, the terminal T1). The retained-content ID list is an identifier of an application retained by the terminal Ti.

The user visit path is information indicating in order of connection, servers (for example, the server 2201) to which the terminal Ti connected. For example, “PSv#2→PSv#1” indicates that after connecting to a server identified by the PSvID “PSv#2”, the terminal T1 connected to the server 2201 identified by the PSvID “PSv#1”.

The associated mobile server ID is an identifier identifying the mobile server MSi associated with the terminal Ti, i.e., the mobile server MSi connected to (paired with) the terminal Ti and retained as a set with the terminal Ti. In the example depicted in FIG. 26, the associated mobile server ID “MS1” of the mobile server MS1 connected to the terminal T1 is indicated. The client information 2610 may include the link speed of the terminal Ti.

The mobile server information 2620 includes a mobile server ID, a server type, a connectable device count, a link speed, an operation time, a compliance standard, a frequency band, and an associated client ID. Here, the mobile server ID is an identifier identifying a mobile server MSi (in the example depicted in FIG. 26, the mobile server MS1).

The server type indicates a mobile type or an app type. The mobile type is a type set in a case where the mobile server MSi is implemented by a portable computer different from the terminal Ti. The app type is a type set in a case where the mobile server MSi is implemented by an application executed by the terminal Ti. In the example depicted in FIG. 26, the server type of the mobile server MS1 is “mobile type”.

The connectable device count indicates a count of terminals (the number of other terminals Tj) that may be connected concurrently to the mobile server MSi. The link speed indicates the link speed of the mobile server MS1. The operation time is a value that varies according to the electrical power remaining in the battery 2407 depicted in FIG. 24 and indicates the remaining amount of time that the mobile server MSi is able to operate.

The compliance standard is a wireless LAN standard that may be used by the mobile server MSi. The frequency band is a wireless LAN channel that may be used by the mobile server MSi. The associated client ID is an identifier identifying the terminal Ti associated with the mobile server MS1, i.e., the terminal Ti connected to the mobile server MSi and retained as a set with the mobile server MSi. In the example depicted in FIG. 26, an associated client ID “T1” of the terminal Ti connected to the mobile server MS1 is indicated.

When no mobile server MSi is associated with the terminal Ti, the terminal information 2320 of the terminal Ti does not include the mobile server information 2620.

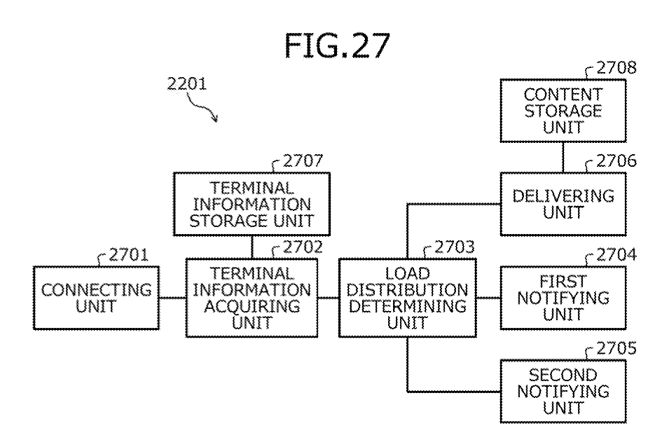

FIG. 27 is a block diagram of an example of a functional configuration of the server 2201 according to the second embodiment. In FIG. 27, the server 2201 is configured including a connecting unit 2701, a terminal information acquiring unit 2702, a load distribution determining unit 2703, a first notifying unit 2704, a second notifying unit 2705, a delivering unit 2706, a terminal information storage unit 2707, and a content storage unit 2708. The connecting unit 2701 to the delivering unit 2706 are functions constituting a control unit and, for example, are implemented by executing on the CPU 301, a program stored in a storage apparatus such as the memory 302 or the disk 305 depicted in FIG. 3 or the like or by the I/F 303. Further, the terminal information storage unit 2707 and the content storage unit 2708 may be implemented by, for example, a storage apparatus such as the memory 302, the disk 305, etc. Processing results of the functional units are stored to, for example, a storage apparatus such as the memory 302, the disk 305, etc.

The connecting unit 2701 connects to a terminal Ti configured to perform wireless communication. In particular, for example, first, the connecting unit 2701 detects, via a wireless LAN access point built into the server 2201, a terminal Ti configured for short-range wireless communication. Next, the connecting unit 2701 performs an authentication process for the detected terminal Ti.

When the terminal Ti is authenticated (authentication successful), the connecting unit 2701 maintains the connection with the terminal Ti. On the other hand, when the terminal Ti is not authenticated (authentication failed), the connecting unit 2701 terminates the connection with the terminal Ti. The authentication process for the terminal Ti may be performed using, for example, the authentication DB 220 like that depicted in FIG. 5.

The terminal information acquiring unit 2702 acquires the terminal information 2320 from the terminal Ti, when the terminal Ti is authenticated. In particular, for example, when the terminal T1 is authenticated, the terminal information acquiring unit 2702 acquires from the terminal T1, the terminal information 2320 like that depicted in FIG. 26.

Further, the terminal information acquiring unit 2702, when acquiring the terminal information 2320 from the terminal Ti, registers the client ID of the terminal Ti into the connected terminal list in the server information 2310. When the mobile server information 2620 is included in the terminal information 2320, the terminal information acquiring unit 2702 further registers the mobile server ID of the mobile server MSi into the connected terminal list in the server information 2310.

The terminal information storage unit 2707 stores the acquired terminal information 2320 of the terminal Ti. As a result, the terminal information 2320 of each terminal T connected to the server 2201 may be stored in the terminal information storage unit 2707.

When the connection between the server 2201 and terminal Ti is terminated, for example, the terminal information 2320 of the terminal Ti is deleted from the terminal Information storage unit 2707. Further, when the connection between the server 2201 and terminal Ti is terminated, for example, the client ID of the terminal Ti and the mobile server ID of the mobile server MSi are deleted from the connected terminal list in the server information 2310.

The load distribution determining unit 2703 extracts from among plural connected terminals T, a terminal Ti associated with a mobile server MSi. The terminal T1 to be extracted is, for example, a terminal Ti to which an application to be delivered has yet to be delivered. An application for which delivery has been made, for example, is identified from the retained-content ID list included in the client information 2610 of the terminal information 2320.

In particular, for example, the load distribution determining unit 2703 refers to the terminal information 2320 stored for each of the terminals T in the terminal information storage unit 2707, and extracts a terminal Ti whose the terminal information 2320 includes the mobile server information 2620. The load distribution determining unit 2703, determines from among mobile servers MS associated with the extracted terminals T, a mobile server MSi to which load distribution (application delivery) is to be requested. In particular, for example, based on the delivery completion time, the operation time, the connectable device count, the link speed, etc., the load distribution determining unit 2703 determines the mobile server MSi to which load distribution is to be requested.

Here, the delivery completion time is the time until delivery of an application to the plural terminals T connected to the server 2201 is completed. The load distribution determining unit 2703, for example, sets a combination of mobile servers MS to which load distribution is to be requested, so that delivery completion time ends sooner.

In more detail, for example, the load distribution determining unit 2703 may determine all of the mobile servers MS associated with the extracted terminals T to be request destinations for load distribution. As a result, the delivery completion time of an application may be shortened as much as possible.

Further, the load distribution determining unit 2703 may refer to the terminal information 2320 of each of the terminals stored in the terminal Information storage unit 2707 to determine as a load-distribution request destination among the mobile servers MS associated with the extracted terminals T, a mobile server MS whose operation time is a threshold α or longer (a load-distribution request destination being a mobile server MS to which load distribution is to be requested). The threshold α may be arbitrarily set and, for example, is set as a value of about 30 minutes. As a result, a mobile server MS whose battery may become exhausted may be excluded from being requested to perform load distribution.

Further, the load distribution determining unit 2703 may refer to the terminal information 2320 of each of the terminals stored in the terminal information storage unit 2707 to determine as load-distribution request destinations among the mobile servers MS whose operation time is the threshold α or longer, the mobile servers MS having the N largest connectable device counts. N may be arbitrarily set and, for example, is set to a value of about 3 devices. As a result, a mobile server MS whose connectable device count is large and whose battery has a low possibility of becoming exhausted may be determined as a mobile server MS to which load distribution is to be preferentially requested.

The load distribution determining unit 2703 may refer to the terminal information 2320 of each of the terminals stored in the terminal information storage unit 2707 to determine as load-distribution request destinations among the mobile servers MS whose operation time is the threshold α or longer, the mobile servers MS having the N fastest link speeds. As a result, a mobile server MS whose link speed is fast and whose battery has a low possibility of becoming exhausted may be determined as a mobile server MS to which load distribution is to be preferentially requested.

Here, as one example, a case will be described in which delivery completion time and operation time are considered to determine a mobile server MSi to which load distribution is to be requested. Here, the plural terminals T connected to the server 2201 installed at a certain event venue are assumed to be “terminals T1 to T50” that is 50 terminals (visitors: 50 people). The number of the connected plural terminals T, for example, may be identified from the connected terminal list in the server information 2310.

Further, a case is assumed where an application of 10 MB is to be distributed to the terminals T1 to T50 all at once and among the terminals T1 to T50, the terminals T1, T3, T5 (3 visitors) may provide the mobile servers MS1, MS3, MS5 by 802.11g. The mobile servers MS associated with the connected plural terminals T, for example, are identified from the connected terminal list in the server information 2310.

First, the application of 10 MB is assumed to be distributed all at once to the terminals T1 to T50 by only the server 2201 configured for 802.11n (20 MHZ), and 802.11n (20 MHZ) TCP throughput (calculated value) is assumed to be “40 Mbps”. In this case, the total transfer amount to the 50 devices is 500 MB and the delivery completion time is about 100 seconds (=500 MB+40 Mbps).

Next, an application of 10 MB is assumed to be distributed all at once to the terminals Ti to T50 by the server 2201 and the mobile server MS1. Further, 802.11n (20 MHZ) TCP throughout is assumed to be “40 Mbps” and 802.11g TCP throughput is assumed to be “20 Mbps”.

In this case, the overall delivery completion time becomes shorter when the delivery completion time of the server 2201 and the delivery completion time of the mobile server MS1 become equal. For example, when the number of terminals to which the mobile server MS1 delivers an application is x terminals, the delivery completion time of the server 2201 may be expressed by “(50−x)×10 MB+40 Mbps”. Further, the delivery completion time of the mobile server MS1 may be expressed by “x×10 MB+20 Mbps”. The overall delivery completion time is about 66 seconds (the server 2201: 33 terminals, the mobile server MS1: 17 terminals).

Next, an application of 10 MB is assumed to be distributed all at once to the terminals T1 to T50 by the server 2201, the mobile server MS1, and the mobile server MS3. Further, 802.11n (20 MHZ) TCP throughput is assumed to be “40 Mbps” and 802.11g TCP throughput is assumed to be “20 Mbps”.

In this case, the overall delivery completion time is about 50 seconds (the server 2201: 25 terminals, the mobile server MS1: 12.5 terminals, the mobile server MS3: 12.5 terminals). The number of terminals to which the mobile servers MS1, MS3 each deliver an application is assumed to be the same.

Next, an application of 10 MB is assumed to be distributed to the terminals T1 to T50 all at once by the server 2201, the mobile server MS1, the mobile server MS3, and the mobile server MS5. Further, 802.11n (20 MHZ) TCP throughput is assumed to be “40 Mbps” and 802.11g TCP throughput is assumed to be “20 Mbps”.

In this case, the overall delivery completion time is about 40 seconds (the server 2201: 20 terminals, the mobile server MS1: 10 terminals, the mobile server MS3: 10 terminals, the mobile server MS5: 10 terminals). Therefore, the overall delivery completion time is soonest when the application of 10 MB is distributed all at once by the server 2201 and the mobile servers MS1, MS3, MS5.

Here, the operation times of the mobile servers MS1, MS3, MS5 are assumed to be 9 hours, 8 hours, and 17 minutes, respectively, and the threshold α is assumed to be “30 minutes”. In this case, the operation time of the mobile server MS5 “17 minutes” is shorter than the threshold α. Therefore, the mobile server MS5 whose battery has a possibility of becoming exhausted is excluded from being requested to perform load distribution. As a result, the mobile servers MS to which load distribution is to be requested are determined to be the two mobile servers including the mobile server MS1 and the mobile server MS3.

Further, the load distribution determining unit 2703 extracts from the connected plural terminals T, a terminal Tj that is to switch the connection destination thereof (j≠i, j=1, 2, . . . , n). The terminal Tj to be extracted is, for example, a terminal Tj to which an application to be delivered has yet to be delivered. The load distribution determining unit 2703 allocates to extracted terminals Tj to the mobile servers MS determined as request destinations for load distribution, so that the overall delivery completion time becomes shorter.

Here, as in the example described above, 2 mobile servers (the mobile server MS1 and the mobile server MS3) are assumed to be determined as request destinations for load distribution.

In this case, as described above, the number of terminals allocated to the server 2201 when the overall delivery completion time (about 50 seconds) becomes shorter is 25 terminals. Further, the number of terminals allocated to the mobile servers MS1, MS3 is the remaining 25 terminals. In other words, among the connected terminals Ti to T50, the number of the terminals T that are to each switch the connection destination thereof is 25 terminals.

Therefore, the load distribution determining unit 2703 extracts from the connected terminals T1 to T50, 25 terminals T that are to each switch the connection destination thereof. However, the terminals T1, T3 associated with the mobile servers MS1, MS3 that are determined as request destinations for load distribution are excluded from being extraction candidates.

In particular, for example, the load distribution determining unit 2703 may extract in descending order of a download wait time, 25 terminals T that are to switch the connection destination thereof. The download wait time is the time that elapses after a terminal T waiting to download an application connects to the server 2201. Further, for example, the load distribution determining unit 2703 may preferentially select as a terminal that is to switch the connection destination thereof, a terminal T whose link speed is close to that of the mobile servers MS1, MS3 determined as load-distribution request destinations.

Further, the load distribution determining unit 2703 allocates the extracted terminal T a mobile server MS determined as a load-distribution request destination. In particular, for example, the load distribution determining unit 2703 allocates to the mobile servers MS1, MS3 determined as load-distribution destinations, 25 terminals T extracted as terminals T that are to switch the connection destination thereof.

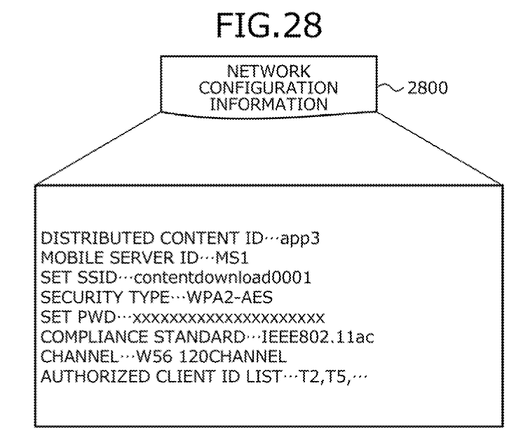

The client IDs identifying the terminals allocated to the mobile servers MS1, MS3, for example, are set in an authorized client ID list described hereinafter (for example, refer to FIG. 28) in the network configuration information.

The first notifying unit 2704 transmits to the terminal Ti associated with a mobile server MSi determined as a load-distribution request destination, an operation instruction for the mobile server MSi. In particular, for example, the first notifying unit 2704 transmits the operation instruction for the mobile server MSi by a push notification. The operation instruction for the mobile server MSi includes, for example, network configuration information for building a wireless LAN.

Here, a case in which the mobile server MS1 is determined as a load-distribution request destination will be described as an example and a detailed example of the network configuration information included in an operation instruction for the mobile server MS1 will be described.

FIG. 28 is a diagram depicting a detailed example of network configuration information. In FIG. 28, network configuration information 2800 includes a distributed content ID, a mobile server ID, a set SSID, a security type, a set PWD, a compliance standard, a channel, and an authorized client ID list.

Here, the distributed content ID is an identifier identifying an application to be delivered. The mobile server ID is an identifier identifying a mobile server MSi to which load distribution is to be requested. The set SSID is an identifier of a wireless LAN access point implemented by the mobile server MSi when operating as an access point.

Further, the security type, the set PWD, the compliance standard, and the channel are the encryption scheme, the password, the compliance standard, and the channel used in the wireless LAN built by the mobile server MSi. The authorized client ID list is a list of client IDs identifying the terminals Tj that are delivery destinations of the application that is to be delivered.

Here, the description returns to FIG. 27. The second notifying unit 2705 transmits to the terminals T extracted as terminals that are to switch the connection destination thereof, a switching instruction instructing to switch the connection destination to a mobile server MSi. Here, the mobile server MSi that is to be the connection destination is the mobile server MSi to which the terminal T that is to switch the connection destination thereof is allocated among the mobile servers MS determined as load-distribution request destinations.

In particular, for example, the second notifying unit 2705 uses a push notification to transmit the switching instruction instructing the connection destination to be switched to the mobile server MSi. Further, the switching instruction includes, for example, network information for connecting to the wireless LAN built by the mobile server MSi that is the connection destination.

Here, a case in which a mobile server MS1 is the connection destination will be described as an example and a detailed example of the network information included in the switching instruction in this case will be described.

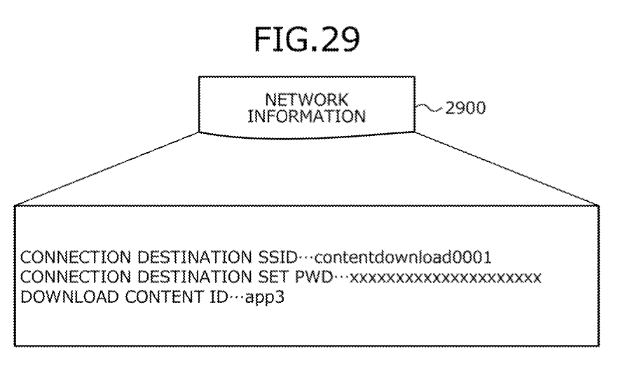

FIG. 29 is a diagram depicting a detailed example of network information. In FIG. 29, network information 2900 includes a connection destination SSID, a connection destination set PWD, and a download content ID.

Here, the connection destination SSID is an identifier of the access point implemented when the mobile server MSi that is the connection destination operates as a wireless LAN access point. The connection destination set PWD is the password used in the wireless LAN built by the mobile server MSi that is the connection destination. The download content ID is an identifier of an application that is to be downloaded from the mobile server MSi that is the connection destination.

Here, the description returns to FIG. 27. The content storage unit 2708 stores the application to be delivered (hereinafter, “delivery app”). In particular, for example, the content storage unit 2708 stores an application registered by a manager of the application delivery system 2300. When a new application is registered, for example, the content ID of the new application is registered into the retained-content ID list in the server information 2310.

The delivering unit 2706 delivers the delivery app to the terminal Ti. Here, the delivery app is, for example, an application stored in the content storage unit 2708. Further, the delivery app is encrypted. Therefore, the delivering unit 2706 may deliver together with the delivery app, a decryption key for decrypting the delivery app. Further, the delivering unit 2706 may transmit the decryption key for the delivery app to the terminal Ti that received the delivery app in response to receiving an acquisition request for the description key from the terminal Ti.

In particular, for example, the delivering unit 2706 transmits the delivery app to the terminals T that are among the connected plural terminals T, excluding the terminals T that are to switch the connection destination thereof. At this time, the delivering unit 2706 may preferentially transmit the delivery app from a terminal Ti associated with a mobile server MSi determined as a load-distribution request destination. As a result, the delivery app may be preferentially delivered to the user of the mobile server MSi that is to be a load-distribution request destination.

The load distribution determining unit 2703, for example, may determine at predetermined time intervals, a mobile server MSi that is to be a load-distribution request destination from the connected plural terminals. Further, for example, each time a terminal Ti associated with a mobile server MSi connects, the load distribution determining unit 2703 may determine the mobile server MSi associated with the terminal Ti to be a load-distribution request destination.

) Further, for example, when a terminal count of the connected plural terminals T (for example, a count of terminals to which a delivery app has not yet been delivered) is a predetermined terminal count or higher, the load distribution determining unit 2703 may determine a mobile server MSi that is to be a load-distribution request destination. Further, when only the server 2201 is to deliver a delivery app and the delivery completion time is a predetermined time or longer, the load distribution determining unit 2703 may determine a mobile server MSi as a load-distribution request destination. As a result, when no sudden increase in load is expected at the server 2201, the server 2201 alone may deliver a delivery app.

The server 2201 may have a same function as that of the server 101 described in the first embodiment (for example, refer to FIG. 8).

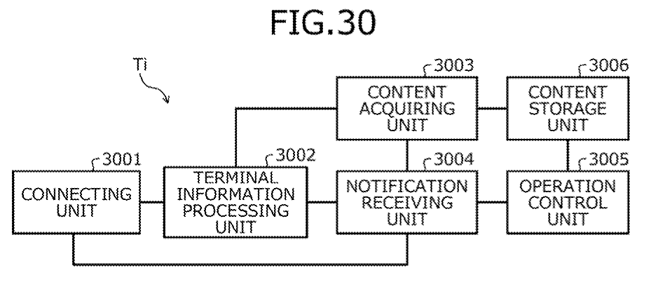

FIG. 30 is a block diagram of an example of a functional configuration of the terminal Ti according to the second embodiment. In FIG. 30, terminal Ti is configured including a connecting unit 3001, a terminal information processing unit 3002, a content acquiring unit 3003, a notification receiving unit 3004, an operation control unit 3005, and a content storage unit 3006. The connecting unit 3001 to the operation control unit 3005 are functions constituting a control unit. In particular, for example, the functions are implemented by executing on the CPU 401, a program stored in the memory 402 depicted in FIG. 4, or by the public network I/F 405 or the short-range wireless I/F 406. Further, for example, the content storage unit 3006 may be implemented by the memory 402. Further, processing results of the functional units, for example, are stored to the memory 402.

The connecting unit 3001 connects to the server 2201 configured to perform wireless communication. In particular, for example, first, the connecting unit 3001 searches for the server 2201 configured for short-range wireless communication. Next, the connecting unit 3001 connects to the discovered server 2201 and performs an authentication process for the terminal Ti. Here, when the terminal Ti is authenticated (authentication successful), the connection with the server 2201 is maintained. On the other hand, when the terminal Ti is not authenticated (authentication failed), the connection with the server 2201 is terminated.

The terminal Information processing unit 3002 transmits the terminal information of the terminal Ti to the connected server 2201. In particular, for example, when the mobile server MSi is connected to the terminal Ti, the connecting unit 3001 uploads to the server 2201, the terminal information 2320 like that depicted in FIG. 26. A connection process (pairing) of the terminal Ti and the mobile server MSi is performed, for example, by user input.

The content acquiring unit 3003 acquires a delivery app. In particular, for example, the content acquiring unit 3003 downloads a delivery app from the connected server 2201 and thereby acquires the delivery app. For example, a decryption key for decrypting the delivery app is appended to the delivery app. The acquired delivery app is stored to, for example, the content storage unit 3006.

The content acquiring unit 3003 may transmit an acquisition request for the decryption key to the server 2201 and thereby acquire the decryption key for the delivery app from the server 2201.

The notification receiving unit 3004 receives from the connected server 2201, an operation instruction for the mobile server MSi connected to the terminal Ti. The operation instruction for the mobile server MSi includes, for example, the network configuration information 2800 like that depicted in FIG. 28.

The operation instruction for the mobile server MSi is received when the mobile server MSi is connected to the terminal Ti and the mobile server MSi has been determined as a load-distribution request destination.

The operation control unit 3005, when an operation instruction for the mobile server MSi is received, enables a function of the mobile server MSi connected to the terminal Ti. In particular, for example, the operation control unit 3005 uploads to the mobile server MSi, network configuration information (for example, the network configuration Information 2800) included in the operation instruction and instructs the mobile server MSi to perform network configuration based on the network configuration information.

Further, the operation control unit 3005 transmits a delivery app stored in the content storage unit 3006 to the mobile server MSi connected to the terminal Ti. In particular, for example, the operation control unit 3005 may upload a delivery app to the mobile server MSi, when the operation instruction for the mobile server MSi is received.

When the mobile server MSi is implemented by an application, the network configuration information and the delivery app are notified by communication between applications.

Further, the notification receiving unit 3004 receives from the connected server 2201, a switching instruction instructing the connection destination to be switched to a mobile server MSj. In particular, for example, the notification receiving unit 3004 receives, by a push notification, the switching instruction instructing the connection destination to be switched to the mobile server MSj. The switching instruction includes, for example, the network information 2900 like that depicted in FIG. 29.

Further, the connecting unit 3001 switches the connection destination from the server 2201 to the mobile server MSj, when the switching instruction instructing the connection destination to be switched to the mobile server MSj is received. In particular, for example, the connecting unit 3001 terminates the connection with the server 2201 and uses the connection destination SSID, the connection destination set PWD described in the network information 2900 included in the switching instruction to connect to the wireless LAN built by the mobile server MSj.

Further, when the connection destination is switched to the mobile server MSj, the content acquiring unit 3003 downloads a delivery app from the connected mobile server MSj and thereby acquires the delivery app.

The terminal Ti may have a same function as the terminal Ti described in the first embodiment (for example, refer to FIG. 9).

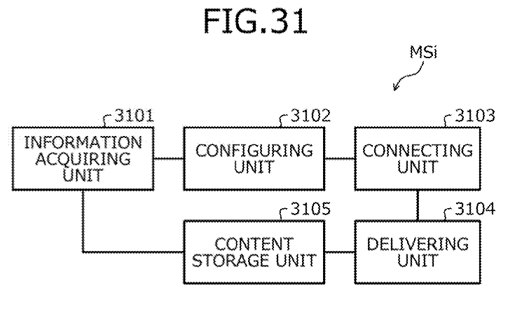

FIG. 31 is a block diagram of an example of a functional configuration of the mobile server MSi according to the second embodiment. In FIG. 31, the mobile server MSi is configured including an information acquiring unit 3101, a configuring unit 3102, a connecting unit 3103, a delivering unit 3104, and a content storage unit 3105. The information acquiring unit 3101 to the delivering unit 3104 are functions constituting a control unit. In particular, for example, the functions are implemented by executing on the CPU 2401, a program stored in the memory 2402 depicted in FIG. 24, or by the I/F 2403. Further, the content storage unit 3105 is implemented by, for example, the memory 2402. Processing results of the functional units are stored to, for example, the memory 2402.

The information acquiring unit 3101 acquires a delivery app. In particular, for example, the information acquiring unit 3101 downloads a delivery app from the connected terminal Ti and thereby acquires the delivery app. For example, a decryption key for decrypting the delivery app is appended to the delivery app. The acquired delivery app is stored to, for example, the content storage unit 3105.

Further, the information acquiring unit 3101 receives network configuration information (for example, the network configuration information 2800) from the connected terminal Ti.

The configuring unit 3102 performs network configuration based on the received network configuration information. In particular, for example, the configuring unit 3102 uses the set SSID, the security type, and the set PWD described in the network configuration information 2800 to build a wireless LAN.

The connecting unit 3103 connects to a terminal Tj configured for short-range wireless communication. In particular, for example, first, the connecting unit 3103 detects a terminal Tj configured for short-range wireless communication. Next, the connecting unit 3103 performs an authentication process for the detected terminal Tj. Here, when the terminal Tj is authentication (authentication successful), the connecting unit 3103 maintains the connection with the terminal Tj. On the other hand, when the terminal Tj is not authenticated (authentication failed), the connecting unit 3103 terminates the connection with the terminal Tj. The authentication process for the terminal Tj uses, for example, the set PWD and the authorized client ID list described in the network configuration information 2800.

The delivering unit 3104 delivers a delivery app to the connected terminal Tj. The delivery app is, for example, an application stored in the content storage unit 3105. In particular, for example, the delivering unit 3104 may transmit to the connected terminal Tj, the delivery app and a decryption key for decrypting the delivery app.

The mobile server MSi, for example, may terminate a server function of delivering a delivery app, when delivery of the delivery app to all of the terminals T identified by the client IDS included in the authorized client ID list has been completed.

A procedure of a terminal information upload process by the terminal Ti will be described.

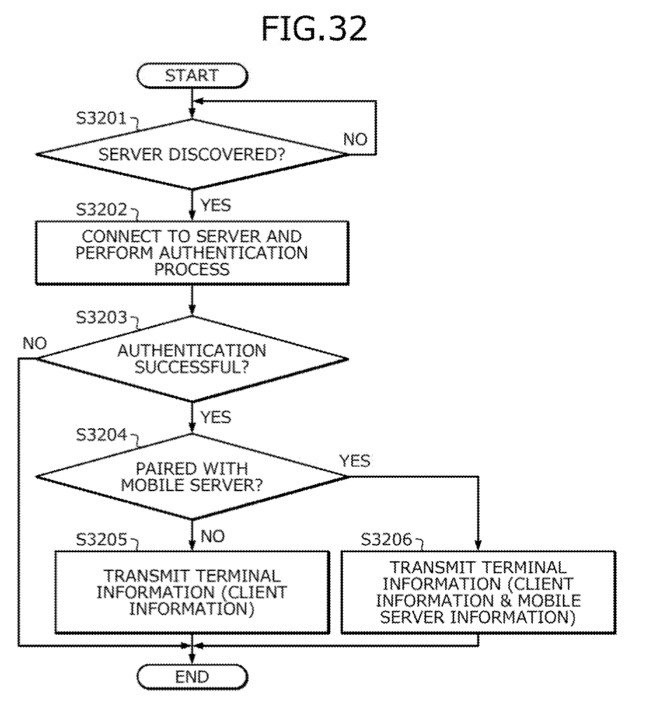

FIG. 32 is a flowchart of an example of a procedure of the terminal information upload process by the terminal Ti according to the second embodiment. In the flowchart depicted in FIG. 32, first, the terminal Ti searches for the server 2201 configured for short-range wireless communication and determines whether the server 2201 has been discovered (step S3201).

Here, the terminal Ti waits until the server 2201 is discovered (step S3201: NO). When the server 2201 is discovered (step S3201: YES), the terminal T1 connects to the server 2201 and performs an authentication process (step S3202). The terminal Ti determines whether authentication of the terminal Ti is successful (step S3203).

When authentication of the terminal T1 fails (step S3203: NO), the terminal Ti ends a series of operations according to the flowchart. On the other hand, when authentication of the terminal Ti is successful (step S3203: YES), the terminal Ti determines whether the terminal Ti is paired with a mobile server MSi (step S3204).

When the terminal Ti is not paired with a mobile server MSi (step S3204: NO), the terminal Ti transmits terminal information including client information to the server 2201 (step S3205) and ends a series of operations according to the flowchart.

On the other hand, when the terminal Ti is paired with a mobile server MSi (step S3204: YES), the terminal Ti transmits terminal information including client information and mobile server information to the server 2201 (step S3206) and ends a series of operations according to the flowchart. As a result, terminal Information of the terminal Ti may be uploaded to the server 2201.

A procedure of a load distribution process by the server 2201 will be described.

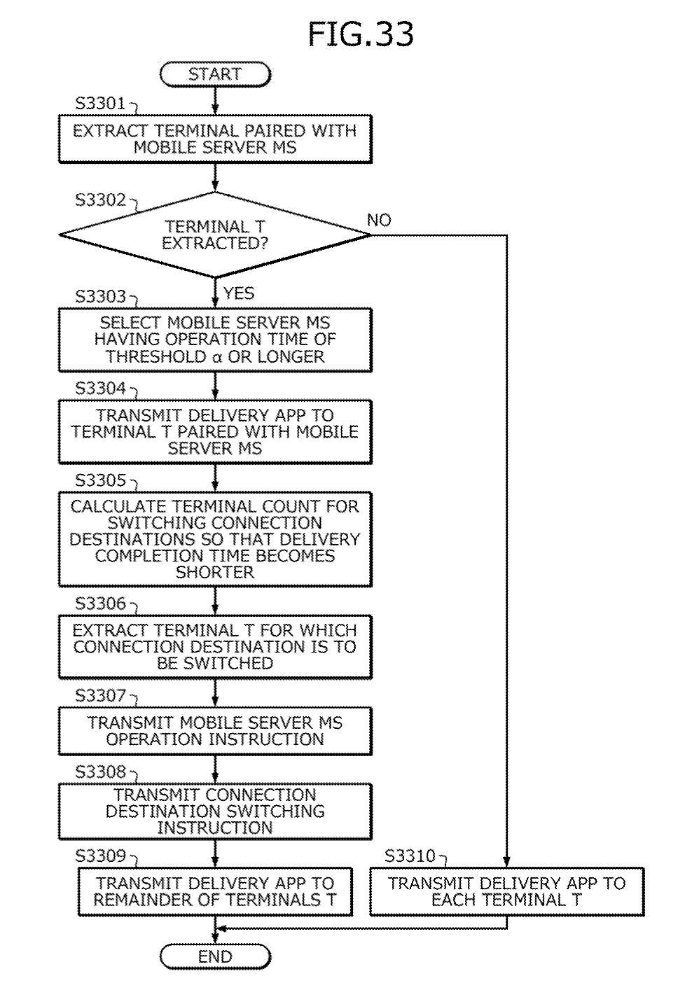

FIG. 33 is a flowchart of an example of a procedure of the load distribution process by the server 2201 according to the second embodiment. In the flowchart depicted in FIG. 33, first, the server 2201 refers to the terminal information 2320 of each of the terminals T and from the connected plural terminals T, extracts terminals T paired with a mobile server MS (step S3301).

Next, the server 2201 determines whether a terminal T paired with a mobile server MS has been extracted (step S3302). When a terminal T has been extracted (step S3302: YES), the server 2201 refers to the terminal information 2320 of the extracted terminal T and selects as a load-distribution request destination, a mobile server MS whose operation time is the threshold α or longer (step S3303).

Next, the server 2201 transmits a delivery app to a terminal T paired with the selected mobile server MS (step S3304). The server 2201 calculates a terminal count of the terminals T that are switch the connection destination thereof; the server 2201 calculates the terminal count so that the delivery completion time when the selected mobile server MS is used becomes shorter (step S3305).

Next, the server 2201 extracts from the connected plural terminals T, the calculated terminal count of terminals T that are to switch the connection destination thereof (step S3306). The server 2201 transmits an operation instruction for a mobile server MS to a terminal T paired with the selected mobile server MS (step S3307). Next, the server 2201 transmits to the extracted terminals T that are to switch the connection destination thereof, a switching instruction instructing to switch the connection destination to the mobile server MS (step S3308).

The server 2201 transmits a delivery app to remaining terminals T (step S3309), ending a series of operations according to the flowchart. A remaining terminal T is a terminal T among the connected plural terminals T, excluding a terminal T paired with a mobile server MS that is a load-distribution request destination and a terminal that is to switch the connection destination thereof.

At step S3302, when no terminal T paired with a mobile server MS is extracted (step S3302: NO), the server 2201 transmits a delivery app to each of the connected terminals T (step S3310), ending a series of operations according to the flowchart.

As a result, a mobile server MS paired with a connected terminal T may be used to distribute a delivery app.

A procedure of a mobile server enabling process by a terminal Ti paired with a mobile server MS that is a load-distribution request destination will be described.

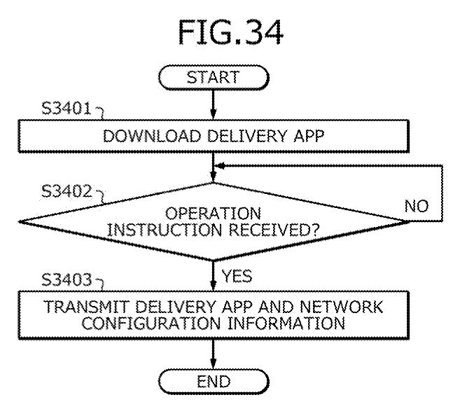

FIG. 34 is a flowchart of an example of a procedure of the mobile server enabling process by a terminal Ti according to the second embodiment. In the flowchart depicted in FIG. 34, the terminal Ti downloads a delivery app from the connected server 2201 (step S3401). Next, terminal Ti determines whether an operation instruction for the mobile server MSi paired with the terminal Ti has been received from the connected server 2201 (step S3402).

Here, the terminal Ti waits until an operation instruction for the mobile server MSi is received (step S3402: NO). When an operation instruction for the mobile server MSi is received (step S3402: YES), the terminal Ti transmits to the mobile server MSi, the delivery app and the network configuration information included in the operation instruction for the mobile server MSi (step S3403), ending a series of operations according to the flowchart.

As a result, in response to the operation instruction from the server 2201, the application delivery function (server function) of the mobile server MS1 is enabled.

A procedure of the application delivery process by a mobile server MSi will be described.

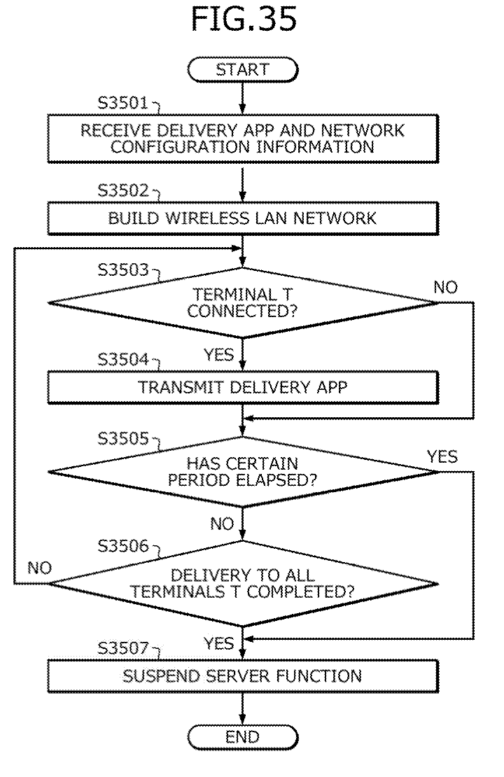

FIG. 35 is a flowchart of an example of the procedure of the application delivery process by the mobile server MSi according to the second embodiment. In the flowchart depicted in FIG. 35, first, the mobile server MSi receives from a paired terminal Ti, a delivery app and network configuration information (step S3501).

Next, the mobile server MSi performs network configuration based on the received network configuration information and thereby builds a network of the wireless LAN (step S3502). The mobile server MSi determines whether a terminal T included in the authorized client ID list in the network configuration information is connected, via the built wireless LAN (step S3503).

When no terminal T is connected (step S3503: NO), the mobile server MSi transitions to step S3505. On the other hand, when a terminal T is connected (step S3503: YES), the mobile server MSi transmits the received delivery app to the terminal T (step S3504).

Next, the mobile server MSi determines whether a certain period has elapsed since the network configuration at step S3502 (for example, 1 to 2 hours) (step S3505). When the certain period has elapsed (step S3505: YES), the mobile server MSi transitions to step S3507.

On the other hand, when the certain period has not elapsed (step S3505: NO), the mobile server MSi determines whether delivery of the delivery app to all of the terminals T included in the authorized client ID list has been completed (step S3506). When delivery of the delivery app has not been completed (step S3506: NO), the mobile server MSi returns to step S3503.

On the other hand, when delivery of the delivery app has been completed (step S3506: YES), the mobile server MSi terminates the server function of delivering an application (step S3507), ending a series of operations according to the flowchart. As a result, a delivery app downloaded from the paired terminal Ti may be delivered to the terminals T included in the authorized client ID list.

A procedure of an application acquiring process by a terminal Ti that is to switch the connection destination thereof will be described.

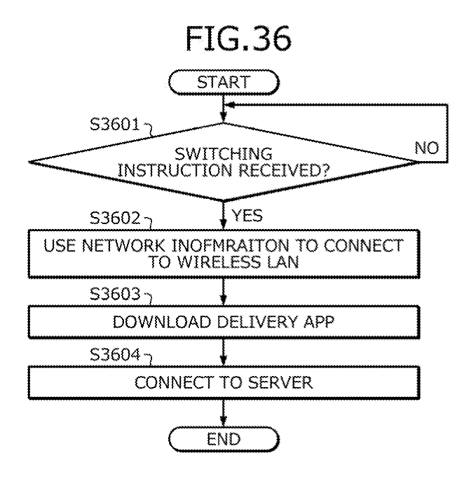

FIG. 36 is a flowchart of an example of the procedure of the application acquiring process by the terminal Ti according to the second embodiment. In the flowchart depicted in FIG. 36, first, the terminal Ti determines whether a switching instruction to switch the connection destination to a mobile server MS has been received from the server 2201 (step S3601).

Here, the terminal Ti waits for a switching instruction (step S3601: NO). When a switching instruction is received (step S3601: YES), the terminal Ti terminates the connection with the server 2201 and uses the network information included in the received switching instruction to connect to a wireless LAN built by the mobile server MS (step S3602).

Next, the terminal Ti downloads a delivery app from the mobile server MS, via the wireless LAN (step S3603). The terminal Ti terminates the connection with the mobile server MS and reconnects to the server 2201, when downloading of the delivery app is finished (step S3604), ending a series of operations according to the flowchart. As a result, the terminal Ti may connect to a wireless LAN specified by the server 2201 and download a delivery app.

As described above, the server 2201 according to the second embodiment enables extraction of a terminal T associated with a mobile server MS from among connected plural terminals T, and the server 2201 enables determination of a mobile server MS that is to be requested to distribute load for delivering a delivery app.

In particular, for example, the server 2201 may determine all mobile servers MS associated with the extracted terminals T to be load-distribution request destinations. As a result, the delivery completion time until a delivery app is delivered to the connected plural terminals T may be shortened.

Further, for example, the server 2201 may determine a mobile server MS whose operation time is the threshold α or longer to a load-distribution request destination among the mobile servers MS associated with the extracted terminals T. As a result, a mobile server MS whose battery may become exhausted may be excluded from being a load-distribution request destination.

Further, for example, the server 2201 may determine the mobile servers MS having the N largest connectable device counts among the mobile servers MS associated with the extracted terminals T to be a load-distribution request destination. As a result, a mobile server MS having a high connectable device count may be preferentially determined as load-distribution request destinations.

Further, for example, the server 2201 may determine the mobile servers MS having the N fastest link speeds among the mobile servers MS associated with the extracted terminals T as load-distribution request destinations. As a result, a mobile server MS having a fast link speed may be preferentially determined as a load-distribution request destination.

Further, the server 2201 may extract from the connected plural terminals T, terminals T that are to switch the connection destination thereof and may allocate the extracted terminals T to the mobile servers MS determined as load-distribution request destinations. For example, the server 2201 may calculate a terminal count of the terminals T that are to switch the connection destination thereof, the server 2201 calculating the terminal count so that the overall delivery completion time when the mobile server MS that is a load-distribution request destination is used becomes shorter. The server 2201 may extract from among the connected plural terminals T, the calculated terminal count of terminals T that are to switch the connection destination thereof and may allocate, by round-robin, the extracted terminals to the mobile servers MS that are load-distribution request destinations.

Further, the server 2201 may transmit to a terminal Ti associated with a mobile terminal MSi determined as a load-distribution request destination, an operation instruction for the mobile server MSi. As a result, a function of the mobile server MSi to be a load-distribution request destination may be enabled.

Further, the server 2201 may preferentially transmit a delivery app to a terminal Ti associated with a mobile terminal MSi determines as a load-distribution request destination. As a result, the delivery app may be preferentially distributed to the user of a mobile server MSi that is to be a load-distribution request destination.

Further, the server 2201 may transmit to a terminal T extracted as a terminal that is to switch the connection destination thereof, a switching instruction instructing the connection destination to be switched to a mobile server MSi. As a result, the connection destination of some of the terminals T of the connected plural terminals T may be switched to the mobile server MSi that is to be a load-distribution request destination.

Further, the server 2201 may transmit to a terminal Ti associated with a mobile server MSi that is a load-distribution request destination, an operation instruction that includes network configuration information for building a wireless LAN. As a result, the set SSID, the security type, the set PWD, etc. specified by the server 2201 may be used to build a wireless LAN.

Further, the server 2201 may transmit to a terminal T that is to switch the connection destination thereof, a switching instruction that includes network information for connecting to a wireless LAN built by a mobile server MSi. As a result, the connection destination SSID and the connection destination set PWD specified by the server 2201 may be used to connect to the wireless LAN.

Further, a terminal Ti according to the second embodiment may enable a function of a paired mobile server MSi and transmit a delivery app to the mobile server MSi in response to receiving an operation instruction for the mobile server MSi. As a result, a wireless LAN may be built by the mobile server MSi paired with the terminal Ti and a delivery app may be delivered.

Further, a mobile server MSi according to the second embodiment, in response to receiving network configuration information from a paired terminal Ti, may build a wireless LAN based on the network configuration information and deliver a delivery app to another terminal Tj.

Further, a terminal Ti according to the second embodiment, in response to receiving a switching instruction instructing the connection destination to be switched to the mobile server MSj, may switch the connection destination from the server 2201 to the mobile server MSj and download a delivery app.

Therefore, the application delivery system 2300 according to the second embodiment may distribute to the server 2201 and a mobile server MSi, load for delivering a delivery app whereby a concentration of load at the server 2201 may be suppressed. As a result, a delivery app may be quickly distributed to a user at the installation place of the server 2201 whereby delays in the start of a service may be prevented.

Here, shortening of the delivery completion time by the application delivery system 2300 will be described. First, a case in which a delivery app of 10 MB is to be distributed all at once to 50 users at an event venue and 2 users may each provide a mobile server MS of 802.11g is assumed.

In this case, for example, when delivery is performed only by the server 2201 configured for 802.11n (20 MHZ), as described above, the delivery completion time is about 100 seconds. In contrast, when delivery is performed by the server 2201 and 2 mobile servers MS, as described above, the delivery completion time is about 50 seconds. In other words, by using the two mobile servers MS, the delivery completion time is calculated to be about 50 seconds shorter.

Next, a case in which a delivery app of 10 MB is to be successively distributed to 50 users sequentially arriving at an event venue is assumed where 1 to 3 of the visitors may provide mobile servers configured for 802.11g. In this case, when only the server 2201 configured for 802.11n (20 MHZ) performs delivery, the delivery completion time is about 100 seconds.

In contrast, when delivery completion times are calculated while changing the sequence in which the one to three users having a mobile server MS arrive, the calculated shortened times are “83.7 seconds” for 1 mobile server MS, “74.6 seconds” for 2 mobile servers MS, and “68.3 seconds” for 3 mobile servers MS, where, 802.11n (20 MHZ) TCP throughput is assumed to be “40 Mbps” and 802.11g TCP throughout is assumed to be “20 Mbps”.

Next, a case in which a delivery app of 10 MB is to be successively distributed to 50 users sequentially arriving at an event venue is assumed where 1 to 3 visitors may provide mobile servers MS configured for 802.11n (20 MHZ).

In this case, when delivery completion times are calculated while changing the sequence in which the one to three users having a mobile server MS arrive, the calculated shortened times are “75.3 seconds” for 1 mobile server MS, “64.4 seconds” for 2 mobile servers MS, and “57.4 seconds” for 3 mobile servers MS, where, 802.11n (20 MHZ) TCP throughput is assumed to be “40 Mbps”.

The application delivery method described in the embodiments may be implemented by executing on a computer such as a personal computer or a work station, a prepared program. This application delivery program is recorded on a computer-readable recording medium such as a hard disk, a flexible disk, CD-ROM, MO, DVD, etc. and is executed by being read out from the recording medium by the computer. Further, the application delivery program may be distributed through a network such as the Internet or the like.

Nonetheless, with the conventional techniques, access to a server installed at a store, a school, or the like may suddenly increase and load for delivering an application may concentrate. For example, when load concentrates at a server, the distribution of an application to users takes time and delays in the start of a service may be delayed.

According to one aspect of the present invention, an effect is achieved in that load for delivering an application may be distributed.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An application delivery method comprising:
detecting, by a server, a first terminal present in a specific area and transmitting, by the server, to the detected first terminal, a first application associated with the specific area and a second application having a function of relaying the first application to a second terminal; and
invoking, by the first terminal, the second application outside the specific area and transmitting by the first terminal using the second application, the first application to the second terminal that has been detected.

2. The application delivery method according to claim 1, wherein
the first application is encrypted and is decryptable and executable in the specific area.

3. The application delivery method according to claim 2, comprising
performing, by the server, an authentication process for the first terminal in response to detecting the first terminal present in the specific area, the server transmitting the first application and the second application to the first terminal when the first terminal is authenticated.

4. The application delivery method according to claim 3, comprising
performing, by the first terminal, an authentication process of the second terminal in response to detecting the second terminal, the first terminal transmitting the first application to the second terminal when the second terminal is authenticated.

5. The application delivery method according to claim 4, wherein
the first application is encrypted by an encryption key generated using position information corresponding to the specific area, and
the application delivery method comprising
acquiring, by the first terminal, position information of the first terminal and performing, by the first terminal, a decryption process for the first application by a decryption key generated using the acquired position information.

6. The application delivery method according to claim 5, comprising
generating, by the first terminal, the decryption key by providing to a hash function, latitude/longitude information identified from the position information of the first terminal.

7. The application delivery method according to claim 4, comprising
transmitting, by the server, to the first terminal present in the specific area, a decryption key that decrypts the first application; and
decrypting, by the first terminal, the first application using the decryption key received from the server.

8. A server comprising:
a memory; and
a processor coupled to the memory, the processor configured to transmit to a first terminal, when detecting the first terminal present in a specific area, a first application associated with the specific area and a second application invoked outside the specific area and having a function of relaying the first application to a second terminal.

9. An application delivery method comprising:
extracting, by a server, a first terminal associated with a mobile server having a function of delivering an application and a second terminal that is to switch a connection destination, the server extracting the first terminal and the second terminal from a plurality of terminals connected to the server;
transmitting, by the server, the application and an operation instruction for the mobile server to the first terminal; and
transmitting, by the server, to the second terminal, a switching instruction to switch the connection destination to the mobile server,
enabling, by the first terminal, the function of the mobile server and transmitting, by the first terminal, the application to the mobile server, in response to receiving the operation instruction;
switching, by the second terminal, the connection destination from the server to the mobile server, in response to receiving the switching instruction; and
transmitting, by the mobile server, the application to the second terminal, in response to a connection of the second terminal.

10. The application delivery method according to claim 9, comprising
extracting, by the server, from the plurality of terminals, the first terminal associated with the mobile server and for which a remaining operable period of the mobile server is a threshold or longer.

11. The application delivery method according to claim 10, comprising
allocating, by the server, the second terminal to each of a plurality of the first terminals so that a delivery completion time when delivery of the application to the plurality of terminals is complete is reduced, the server allocating the plurality of the first terminals when the plurality of the first terminals is extracted.

12. The application delivery method according to claim 11, wherein
the operation instruction includes network configuration information for building a short-range wireless network,
the switching instruction includes network information for connecting to the short-range wireless network,
the first terminal enabling the function of the mobile server by instructing network configuration based on the network configuration information,
the application delivery method comprising:
building, by the mobile server, the short-range wireless network based on the network configuration information; and
connecting, by the second terminal, to the short-range wireless network based on the network information.

13. The application delivery method according to claim 12, wherein
the server extracts the first terminal based on at least one of a link speed and a connectable device count of each mobile server when a plurality of terminals associated with a mobile server having the function of delivering the application is present.
